(19) United States
(12) Patent Application Publication
(10) Pub. No.: US 2014/0086822 A1
(43) Pub. Date: Mar. 27, 2014

(54) CHLORINE DIOXIDE GENERATION SYSTEMS AND METHODS

(71) Applicant: SIEMENS WATER TECHNOLOGIES LLC, Alpharetta, GA (US)

(72) Inventors: Edward Max Martens, Loveland, CO (US); Glenn Wesley Holden, Spring, TX (US)

(73) Assignee: SIEMENS WATER TECHNOLOGIES LLC, Alpharetta, GA (US)

(21) Appl. No.: 14/089,325

(22) Filed: Nov. 25, 2013

Related U.S. Application Data
(63) Continuation-in-part of application No. 12/790,647, filed on May 28, 2010.
Application No. 12/790,647 is a continuation-in-part of application No. 12/391,154, filed on Feb. 23, 2009.
Application No. 12/391,154 is a division of application No. 10/457,335, filed on Jun. 9, 2003, now Pat. No. 7,504,074.
(60) Provisional application No. 61/182,615, filed on May 29, 2009.
(60) Provisional application No. 60/388,070, filed on Jun. 11, 2002.

(51) Int. Cl. C01B 11/02

(52) U.S. Cl. CPC C01B 11/024
USPC 423/477; 422/111

(57) ABSTRACT

Chlorine dioxide generation systems and methods are disclosed. In some embodiments, an optical analyzer may be positioned along a reactant feed line to measure a reactant concentration. A controller may adjust a flow rate of the reactant in response to information provided by the optical analyzer.

### CROSS-REFERENCE TO RELATED APPLICATIONS

This application is a continuation-in-part of and claims priority under 35 U.S.C. §120 to U.S. patent application Ser. No. 12/391,154 filed on Feb. 23, 2009 which, in turn, is a divisional of and claims priority under 35 U.S.C. §120 to U.S. patent application Ser. No. 10/457,335 filed Jun. 9, 2003, now U.S. Pat. No. 7,504,074 which, in turn, claims priority under 35 U.S.C. §119 to U.S. Provisional Patent Application Ser. No. 60/388,070 filed on Jun. 11, 2002. This application also claims priority under 35 U.S.C. §119 to U.S. Provisional Patent Application Ser. No. 61/182,615 filed on May 29, 2009. Each of these applications is hereby incorporated herein by reference in its entirety for all purposes.

### FIELD OF THE TECHNOLOGY

Embodiments find applicability in the field of chlorine dioxide generation.

### BACKGROUND

Chlorine dioxide is an oxidizing agent which is widely used as a disinfectant, such as in water treatment processes, as well as in bleaching and other applications.

### SUMMARY

Aspects relate generally to chlorine dioxide generation systems and methods designed to produce chlorine dioxide in an efficient, economical and safe manner.

In accordance with one or more aspects, a method of generating chlorine dioxide may comprise supplying sodium chlorite and chlorine to a reaction column under vacuum, measuring a flow rate of sodium chlorite supplied to the reaction column, measuring a concentration of sodium chlorite supplied to the reaction column, measuring a generated chlorine dioxide yield at an outlet of the reaction column, determining a theoretical chlorine dioxide yield based on the measured flow rate and the measured concentration of sodium chlorite, determining a process efficiency by comparing the theoretical chlorine dioxide yield to the generated chlorine dioxide yield measured, comparing the process efficiency to a set point value, and adjusting the flow rate of at least one of sodium chlorite and chlorine to the reaction column if the process efficiency deviates from the set point value.

In some aspects, the concentration of sodium chlorite is measured with an optical analyzer. In at least some aspects, adjusting the flow rate of at least one of sodium chlorite and chlorine is not dependent on linearity of the flow rate with respect to a valve positioning. The flow rate of sodium chlorite may be adjusted in response to the process efficiency deviating from the set point value. The flow rate of sodium chlorite to the reaction column may be continuously adjusted. In some aspects, the process efficiency is at least about 98% with respect to molar conversion.

In accordance with one or more aspects, a method of generating chlorine dioxide may comprise supplying sodium chlorite, hydrochloric acid, and sodium hypochlorite to a reaction column under vacuum, measuring a flow rate of sodium chlorite supplied to the reaction column, measuring a concentration of sodium chlorite supplied to the reaction column, measuring a generated chlorine dioxide yield at an outlet of the reaction column, determining a theoretical chlorine dioxide yield based on the measured flow rate and the measured concentration of sodium chlorite supplied to the reaction column, determining a process efficiency by comparing the theoretical chlorine dioxide yield to the generated chlorine dioxide yield measured, comparing the process efficiency to a set point value; and adjusting the flow rate of at least one of sodium chlorite, hydrochloric acid and sodium hypochlorite if the process efficiency deviates from the set point value.

In some aspects, the method may further comprise measuring a flow rate of sodium hypochlorite supplied to the reaction column. In other aspects, the method may further comprise measuring a concentration of sodium hypochlorite supplied to the reaction column. The flow rate of sodium chlorite may be adjusted in response to the process efficiency deviating from the set point value. The flow rate of sodium chlorite to the reaction column may be continuously adjusted. The flow rate of sodium hypochlorite may be adjusted in response to the process efficiency deviating from the set point value. In at least some aspects, the process efficiency is at least about 98% with respect to molar conversion.

In accordance with one or more aspects, a chlorine dioxide generation system may comprise a reactor column, a source of sodium chlorite reactant fluidly connected to the reaction column, a source of chlorine gas reactant fluidly connected to the reaction column, a first sensor configured to detect a flow rate of at least one of sodium chlorite and chlorine gas delivered to the reaction column, a second sensor configured to detect a chlorine dioxide concentration of a product stream generated by the system, a third sensor configured to detect a sodium chlorite concentration delivered to the reaction column, and a controller in communication with the first, second, and third sensors. The controller may be configured to: determine a theoretical chlorine dioxide production rate based on the flow rate of the at least one of sodium chlorite and chlorine gas detected by the first sensor and the sodium chlorite concentration detected by the third sensor, determine an actual chlorine dioxide production rate based on the chlorine dioxide concentration detected by the second sensor, monitor a process efficiency based on the theoretical chlorine dioxide production rate and the actual chlorine dioxide production rate, and adjust the flow rate of at least one of sodium chlorite and chlorine gas to the reaction column based on the process efficiency.

In some aspects, the third sensor comprises an optical analyzer. In other aspects, the system may be characterized by a molar conversion efficiency of at least about 98%.

In accordance with one or more aspects, a chlorine dioxide generation system may comprise a reaction column, a source of sodium chlorite reactant fluidly connected to the reaction column, a source of sodium hypochlorite reactant fluidly connected to the reaction column, a source of hydrochloric acid reactant fluidly connected to the reaction column, a first sensor configured to detect a flow rate of at least one of sodium chlorite, sodium hypochlorite, and hydrochloric acid delivered to the reaction column, a second sensor configured to detect a chlorine dioxide concentration of a product stream generated by the system, a third sensor configured to detect a concentration of sodium chlorite reactant delivered to the reaction column, and a controller in communication with the first, second, and third sensors. The controller may be configured to: determine a theoretical chlorine dioxide production rate based on the flow rate of the at least one of sodium chlorite, sodium hypochlorite, and hydrochloric acid detected by the first sensor and the sodium chlorite concentration detected by the third sensor, determine an actual chlorine dioxide production rate based on the chlorine dioxide concentration detected by the second sensor, monitor a system efficiency based on the theoretical chlorine dioxide production rate and the actual chlorine dioxide production rate, and adjust the flow rate of at least one of sodium chlorite, sodium hypochlorite, and hydrochloric acid to the reaction column based on the process efficiency.

In some aspects, the system may further comprise a fourth sensor configured to detect a sodium hypochlorite concentration delivered to the reaction column, wherein the controller is in further communication with the fourth sensor. In other aspects, the controller is configured to adjust the flow rates of both sodium chlorite and sodium hypochlorite to the reaction column. In at least some aspects, the system may be characterized by a molar conversion efficiency of at least about 98%.

Still other aspects, embodiments, and advantages of these exemplary aspects and embodiments, are discussed in detail below. Other advantages, novel features and objects will become apparent from the following detailed description when considered in conjunction with the accompanying drawings. Moreover, it is to be understood that both the foregoing information and the following detailed description are merely illustrative examples of various aspects and embodiments, and are intended to provide an overview or framework for understanding the nature and character of the claimed aspects and embodiments.

The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

The accompanying drawings are not intended to be drawn to scale. In the drawings, each identical or nearly identical component that is illustrated in various figures is represented by like numeral. For purposes of clarity, not every component may be labeled in every drawing. Preferred, non-limiting embodiments will be described with reference to the accompanying drawings, in which:

FIG. 1 is a schematic of the prior design of the three chemical chlorine dioxide generator.

FIG. 2 is a schematic representation of a three chemical chlorine dioxide generator in accordance with one or more embodiments.

FIG. 3 is a schematic diagram of the prior method for producing chlorine dioxide.

FIG. 4 is a flow diagram of a method for producing chlorine dioxide in accordance with one or more embodiments.

FIG. 5 is a comparison of o-ring placement in the prior and new design of the chlorine dioxide generator.

FIG. 6 identifies components of a two chemical chlorine dioxide generator.

FIG. 7 identifies components of a three chemical chlorine dioxide generator.

FIG. 8 is a flow diagram of chlorine dioxide production in accordance with one or more embodiments.

FIG. 9 is an illustration of the touch screen.

FIG. 10 is an illustration of the automatic efficiency control screen.

FIG. 11 presents a schematic of a two-reactant chlorine dioxide generation system in accordance with one or more embodiments.

FIGS. 12-14 present schematics of three-reactant chlorine dioxide generation systems in accordance with one or more embodiments.

FIGS. 15A-15C present data pertaining to sodium hypochlorite degradation.

FIG. 16 presents a piping and instrumentation diagram (P&ID) in accordance with one or more embodiments.

FIG. 17 presents a process flow diagram providing a detailed view of the boxed region of FIG. 16.

FIG. 18 presents a PLC schematic in accordance with one or more embodiments.

FIG. 19 presents a controller user interface snapshot in accordance with one or more embodiments.

FIG. 20 presents a P&ID for a two-reactant system in accordance with one or more embodiments.

FIG. 21 presents a P&ID for a three-reactant system in accordance with one or more embodiments.

### DETAILED DESCRIPTION

One or more embodiments may relate generally to chlorine dioxide generation systems and methods.

The following is a brief, non-limiting list of terms and concepts that may be used in accordance with one or more embodiments.

“Gas in air” is escaping gas (e.g., chlorine dioxide) in the air which should not be there. Gas in the air will cause a shut-down of the generator.

“Eductor motive water flow” is a pressure and flow measurement. With a drop of pressure or flow, the vacuum will be broken causing the generator to shut-down.

“Set point deviation” is deviation from the required amount of chlorine dioxide (e.g., the amount of chlorine dioxide per a 24-hour period).

“Generator set point” is the set point for the amount of chlorine dioxide that the generator is scheduled to produce.

“Process Variable” or “Production Value” is the actual amount of chlorine dioxide produced relative to the theoretical amount. This can be determined by the sodium chlorite flow-rate.

“Efficiency” is measured by a stoichiometric amount. For example, the conversion of sodium chlorite to chlorine dioxide. This can also be a measure of yield or purity.

“Real time data” is data produced by the controller on a constant (at all times) basis.

The amount of chlorine gas used in the system is measured in terms of pounds per unit time (e.g., pounds/day).

The Chlorine Dioxide Generation System of this invention may report “Real-time generation efficiency”. That is, the system may continuously give a “read-out” of the operating efficiency of the system (e.g., how efficiently the system is producing chlorine dioxide).

The controller may be programmed to receive “generator effluent analysis”, “eductor water flow rate”, “precursor chemical flow rate” and “process variable verification”.

Programmed into the system may be an inventory of precursor chemicals previously used (e.g., on a monthly basis) to be compared with the current month's usage. If there is a major discrepancy, the system may signal this.

Previous controllers are outdated, expensive, and very tedious to program and/or change operating conditions. A new control scheme has been devised to accommodate better interaction between equipment operators and the controller. The “process controller” may be a combination of a Programmable Logic Controller (PLC) and an interactive Touch Screen Interface. Both devices may be programmed to perform desired functions. The PLC may incorporate a Ladder Logic Program that is used to control various components (flow meters, valves, switches), analyze data (generated or set internally, or input from an external source), monitor alarms status, and provide appropriate outputs. The Touch Screen program may route data to and from the PLC, display outputs from the PLC, and allow control information to be sent to the PLC.

An interactive “Human-Machine-Interface” or HMI may be incorporated that provides the operator with complete details of unit operation. This interface may allow the operator to look at data, monitor conditions and make selections and changes by “touching the screen”. The operator does not need an intimate knowledge of the equipment to achieve a desired result. The new design utilizes multiple PID loop control and a user-friendly touch screen interface. A PID (Proportional, Integral, & Derivative) loop may be used as a method for controlling the process. In an exemplary case, the components are an electronic flow meter, a control valve, and a process controller (computer). For example, the flow of sodium chlorite (a chemical used in the production of chlorine dioxide) may be automatically controlled utilizing a magnetic flow meter that provides an analog signal output that is proportional to the actual flow (e.g., the actual amount of sodium chlorite supplied). A flow control valve may receive the analog signal and adjust the valve position based upon initial setup. A Programmable Logic Controller (PLC) may receive and transmit analog signals from the flow meter (rotameter), to the control valve to control the rate of flow to the value internally computed by the PLC (e.g., amount of sodium chlorite).

Said another way, the PLC may contain the interface connections to the devices in the system that are used for control. A flow meter may provide an analog signal that is in direct proportion to the flow through it. That signal may be input to the PLC and used by the PLC in internal calculations (in the program) to determine whether the measured flow is correct. The PLC may supply an analog output signal to the control valve which opens and closes in proportion to the analog signal sent to it. This process, known as a PID loop, is commonly used to control flow rates. Additional data may also be evaluated in a different fashion. The PLC may monitor the status of a switch (open or closed), and provide a response (alarm, shut down, or other action). The PLC may receive an analog signal from a device and use it to display a tank level condition, or start and stop system components based upon the value of that signal.

Further features incorporated in the design may include all of the normally specified safeties and alarms, but also allow for display of key operating parameters that provide instant information to the operator. Safeties may include devices that transmit a signal to the PLC for processing and comparison to an acceptable range or condition. These conditions are continuously monitored and compared to an acceptable condition as set up in the PLC. Included are flow rates, no flow, low flow, empty tank, gas-in-air, set point deviation, efficiency and others. The number of alarms is limited only by the number of devices in the system. The chlorine dioxide generation system of this invention may be programmed to provide for chemical flow rates, eductor motive water flow rate, generator set point, process variable, chlorine dioxide concentration, efficiency, tank levels, alarm status, etc., along with trending and alarm histories. In addition, real-time data can be accessed to aid in trouble-shooting as well as reporting issues. An example would be the monthly consumption of chemicals involved in the process. All of the data above, along with help and information screens are able to provide guidance.

An innovative approach to display and self-tuning may be incorporated. Real-time generation efficiency can be displayed utilizing continuous generator effluent analysis, eductor water flow rate, precursor chemical flow rates, as well as the process variable. Tuning may occur when the efficiency falls below defined limits and may involve a computed bias to relevant precursor flow rates. The efficient PID loop may provide automatic adjustment of chemical feeds to provide the maximum yield of chlorine dioxide. The PLC may calculate the maximum possible chlorine dioxide theoretically available from the sodium chlorite flow rate. This value may be compared to one calculated from the actual eductor water flow and chlorine dioxide concentration. If the two values differ by more than 5% (this is actually selectable), then a chemical feed adjustment may be made (chlorine gas in the case of a two-chemical system, or sodium hypochlorite and hydrochloric acid in the case of a three-chemical system). The process of comparison may continue until the variation is acceptable.

In a general example of the process for producing chlorine dioxide, the primary precursor chemical may be sodium chlorite solution, normally at a concentration of 25%. At times, other concentrations are used, but would change the chemical reaction. In a two-chemical system, typically, chlorine gas reacts directly with sodium chlorite solution to produce chlorine dioxide. A three-chemical system, typically, uses sodium chlorite (25%), sodium hypochlorite (12.5%), and hydrochloric acid (15%). The net chemical reaction is the same. Sodium hypochlorite and hydrochloric acid react first to produce chlorine gas which then reacts with sodium chlorite to produce chlorine dioxide.

In a non-limiting reaction, the amounts required are:

Sodium Chlorite solution (25%)—0.518 gallons per pound of chlorine dioxide.

Chlorine gas—0.526 pounds per pound of chlorine dioxide.

Sodium Hypochlorite (12.5%)—0.420 gallons per pound of chlorine dioxide.

Hydrochloric Acid (15%)—0.393 gallons per pound of chlorine dioxide.

The measure of efficiency for the process relates the actual amount of chlorine dioxide produced compared to the theoretical amount, based upon the quantity of sodium chlorite used.

In carrying out a specific non-limiting process employing both sodium chlorite, chlorine gas (two reagent process) and water, the concentration of starting sodium chlorite supply is 25% by weight; the concentration of chlorine gas supply is 100% and the amount of water varies dependent upon unit capacity to produce a concentration of chlorine dioxide of less than 3,000 mg/liter. If the amount of chlorine dioxide produced is excessive, adjustment is to be made to the sodium chlorite; and if the desired amount of chlorine dioxide is inadequate, adjustment is to be made to sodium chlorite and chlorine gas.

In carrying out the process, the reactants are fed into a reaction column and react to produce concentrated chlorine dioxide solution where the concentrated chlorine dioxide solution enters the eductor where it is diluted and transported away as a solution.

In a non-limiting three-chemical process for producing chlorine dioxide, sodium chlorite solution 25% by weight; sodium hypochlorite 12.5% by weight and hydrochloric acid 15% by weight are fed into the eductor where a vacuum is produced to pull the precursor chemicals into a reaction column where they react to produce concentrated chlorine dioxide, the system is monitored for optimum chlorine dioxide concentration. If the chlorine dioxide concentration is too high, sodium chlorite feed is reduced; and if the concentration is too low, sodium hypochlorite and hydrochloric acid feeds are increased.

Equipment packaging may be simplified dramatically in accordance with one or more embodiments, allowing for unrestricted access to key components. Ergonomic designs may be incorporated allowing for maintenance and repairs to be made on critical components (flow meters, control valves) without special tools or having to lie down or stand on a ladder.

In accordance with one or more embodiments, the chlorine dioxide generation system does not use gravity feed. Gravity feed (without elevated tanks) will not reliably provide enough motive force for adequate flow. In addition, modern feed practices for chlorine gas require the use of an eductor. This is a safety issue that has been adequately addressed with vacuum regulators and other components that “fail safe” when a line break or other interruption occurs. All liquid feeds for the chlorine dioxide generation system use vacuum eductors. This is particularly advantageous in that with a break in the liquid-feed, the vacuum is broken and the system is signaled to shut-down. A vacuum eductor is used for the chlorine gas supply, and is used in the system for the other chemicals as well. Further, there are inherent safety features associated with eductor feed systems that include automatic shut down of chemical flows when the vacuum is lost, air in-leakage when a line develops a leak, etc.

Relative to the “Process Controller”.

The data fed to the process controller may include among other information, (1) all of the real time information from the precursor chemical electronic flow meters, (2) the eductor water flow meter, (3) the optical analyzer, and (4) other devices that indicate a status via a contact or relay. In addition, (5) input signals from customer devices such as flow meters or dosage settings, along with status indicating devices. The process controller uses all analog signals to determine and control the chemical flows required, and sends output signals to the appropriate control valves to assure proper flow rates. The status signals received are compared to what the process controller expects during normal operation, and are continuously monitored. For example, if a sensor that detects the concentration of chlorine dioxide in air set to close a contact when the concentration exceeds a preset level is connected to the process controller, then that device is continuously monitored by the controller. If the contacts close, indicating a level of chlorine dioxide in air higher than the preset level, the process controller will indicate an alarm condition that will be followed by automatic unit shut down and alarm notification such as a horn, light, or other device.

The chlorine dioxide generation system of this invention may be defined as one comprising means programmed for efficiently manufacturing chlorine dioxide wherein the values of precursor chemicals for manufacturing the chlorine dioxide are supplied to a programmable logic controller and with the programmable logic controller continually making adjustment of the precursor chemicals based on the desired amount of chlorine dioxide to be produced to insure that a substantially optimum amount of chlorine dioxide is produced. In the system all liquids are delivered by vacuum eductors which may be seal-less vacuum eductors. The chlorine dioxide generation system incorporates a touch screen that allows the operator to look at data, make changes and monitor operating conditions. The touch screen provides a “Human-Machine-Interface” for ease in monitoring operation and making changes.

In accordance with one or more embodiments, the chlorine dioxide generation system may have incorporated therein a proportional, integral and derivative loop. The chlorine dioxide generation system also may have a shut-down signal for no flow, low flow, empty tank, gas-in-air and/or set point deviation and may be programmed to compare the current month's consumption of chemicals with past months' consumption of chemicals.

In the system, the chlorine dioxide level is determined by an optical analyzer.

The chlorine dioxide generation system has precursor chemicals supplied through flow meters, valves and other fittings that are substantially free of o-rings.

Further in the chlorine dioxide generation system, there is an improvement comprising supplying the precursor chemical in a system wherein the reaction column, check valve/metering valve assembly, chemical rotameters, tubing connectors and water bleed inlet valve are joined free of o-rings and using devices designed to seal without the use of o-ring seals.

These and other aspects will become apparent from a reading of the following specification taken in conjunction with the enclosed drawings.

A Comparison of Chlorine Dioxide Generators

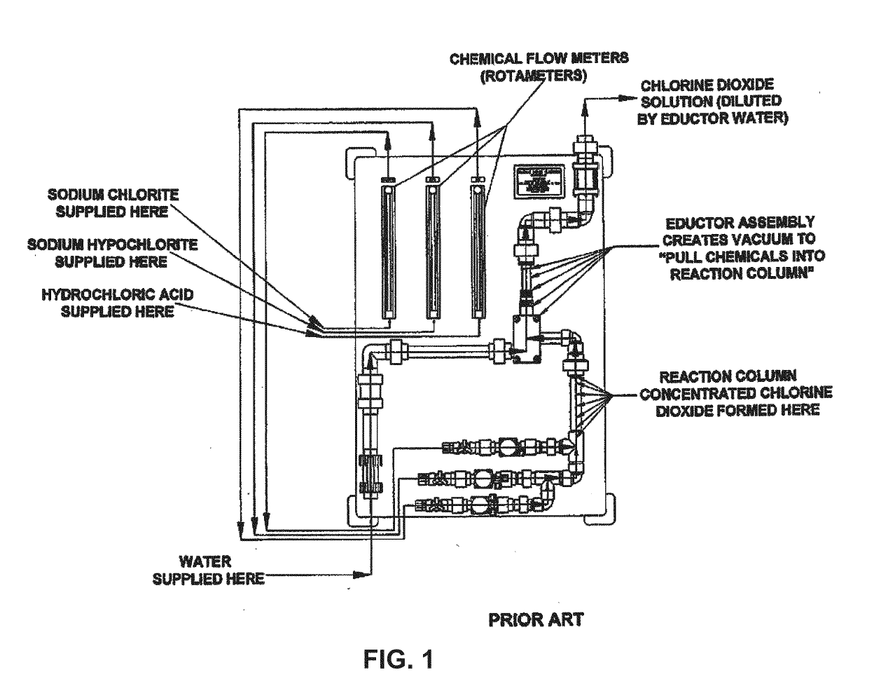

FIG. 1 shows Vulcan Performance Chemicals' prior design for a manual three chemical Chlorine Dioxide “Generator.” The basic concept involves the use of an eductor to create a vacuum to pull the precursor chemicals (e.g., sodium chlorite, sodium hypochlorite and hydrochloric acid) into a reaction column where they react to produce concentrated chlorine dioxide. This chlorine dioxide then enters the eductor where it is diluted and transported away as a solution.

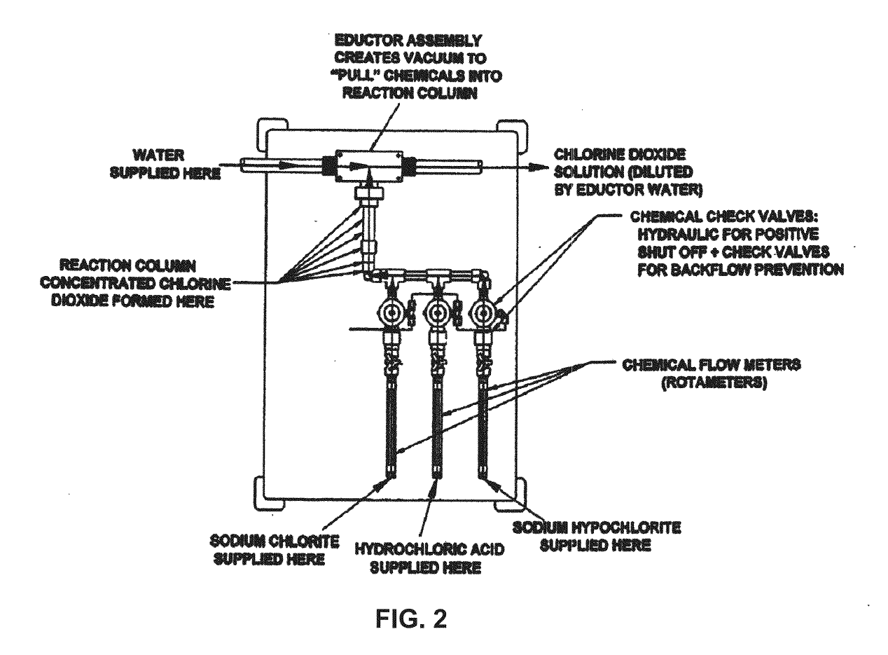

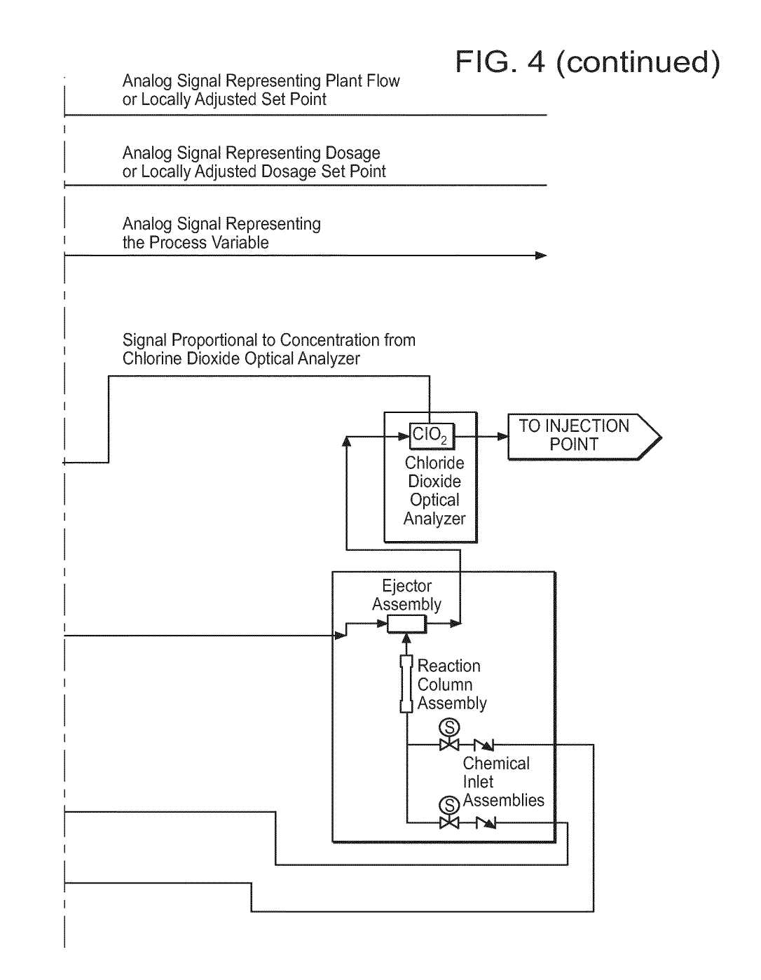

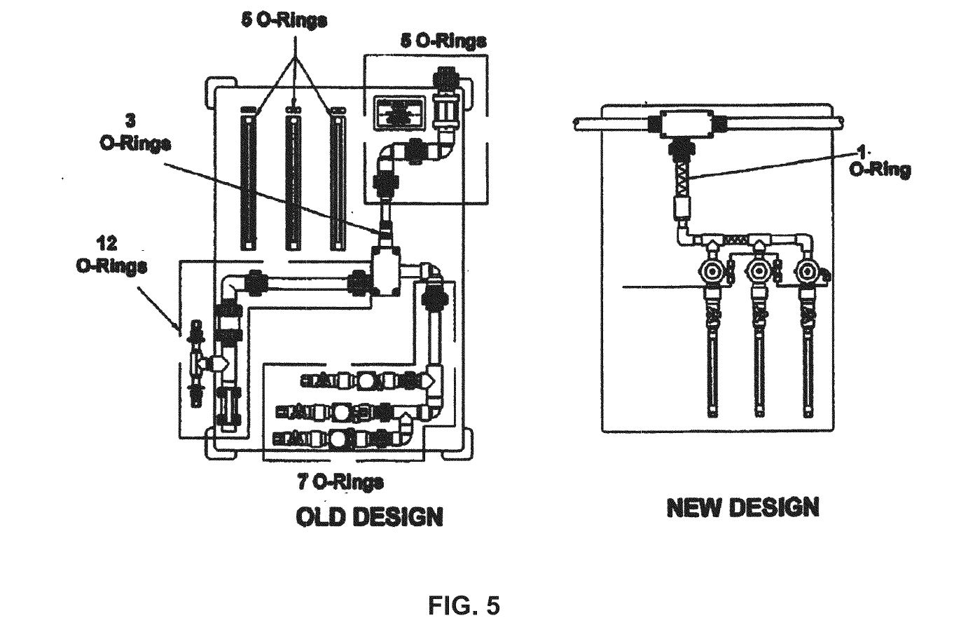

FIG. 2 shows Vulcan Performance Chemicals' new design for a manual three chemical Chlorine Dioxide Generator. The basic operating principles are the same. The improvements involve significant simplification of the flow circuits along with a dramatic reduction in seals and maintenance. These improvements are shown in greater detail in FIG. 5.

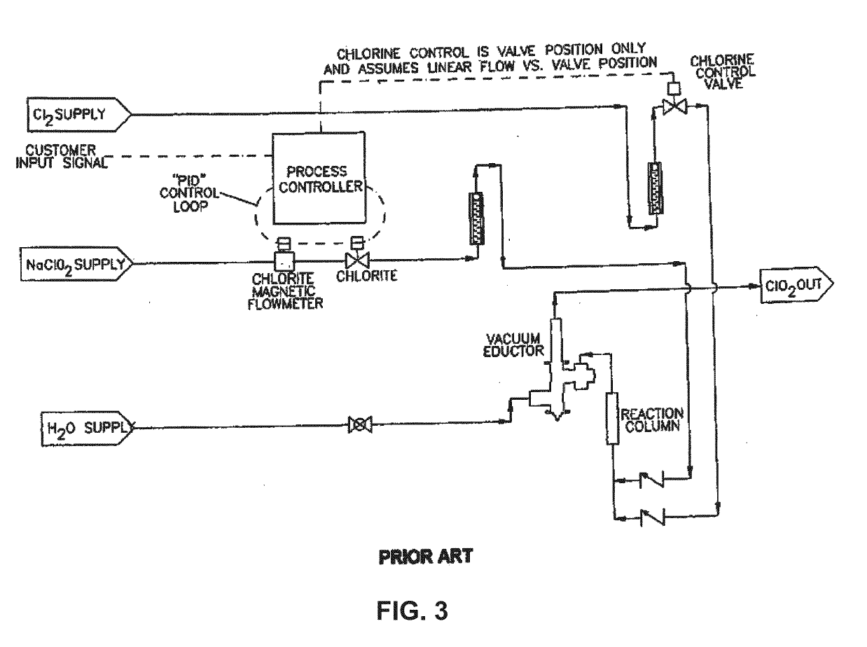

FIG. 3 shows a simple process flow diagram of Vulcan Performance Chemicals' prior art “Automatic” Chlorine Dioxide Generator. “Automatic” means that the unit's production rate can be controlled at a local or remote set point (in pounds per day of chlorine dioxide) automatically. The efficiency of the unit is dependent upon the linearity of the flow of chlorine gas through the chlorine control valve and the valve position. There is no feed-back adjustment of controls.

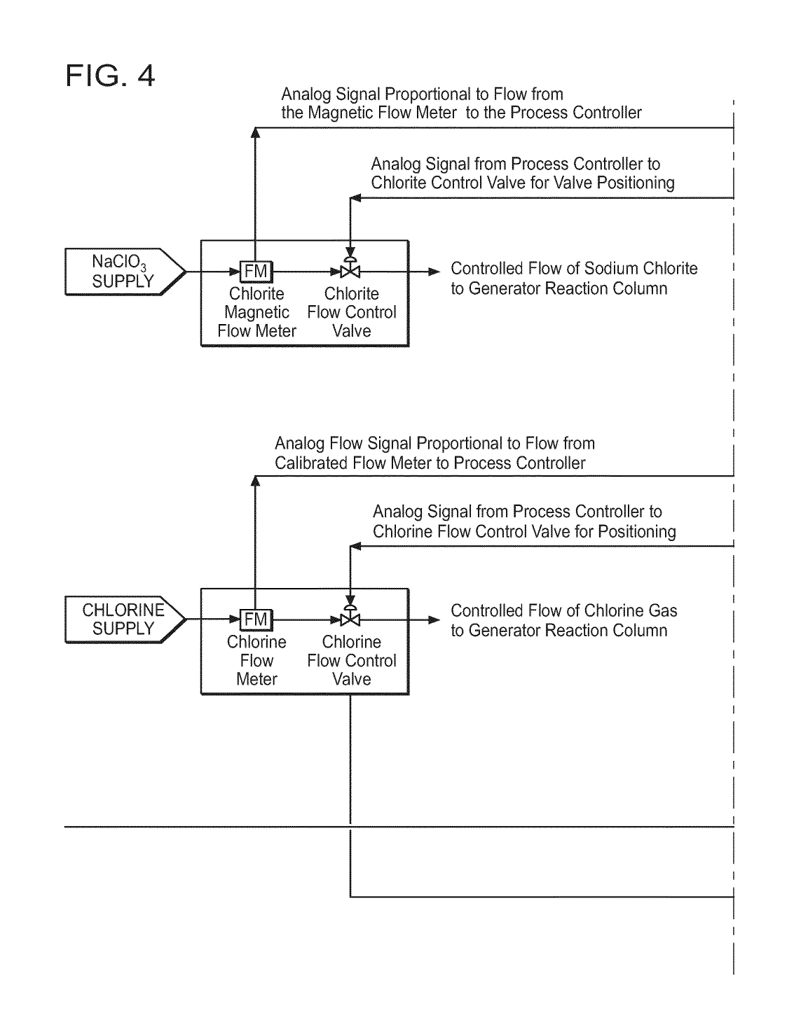

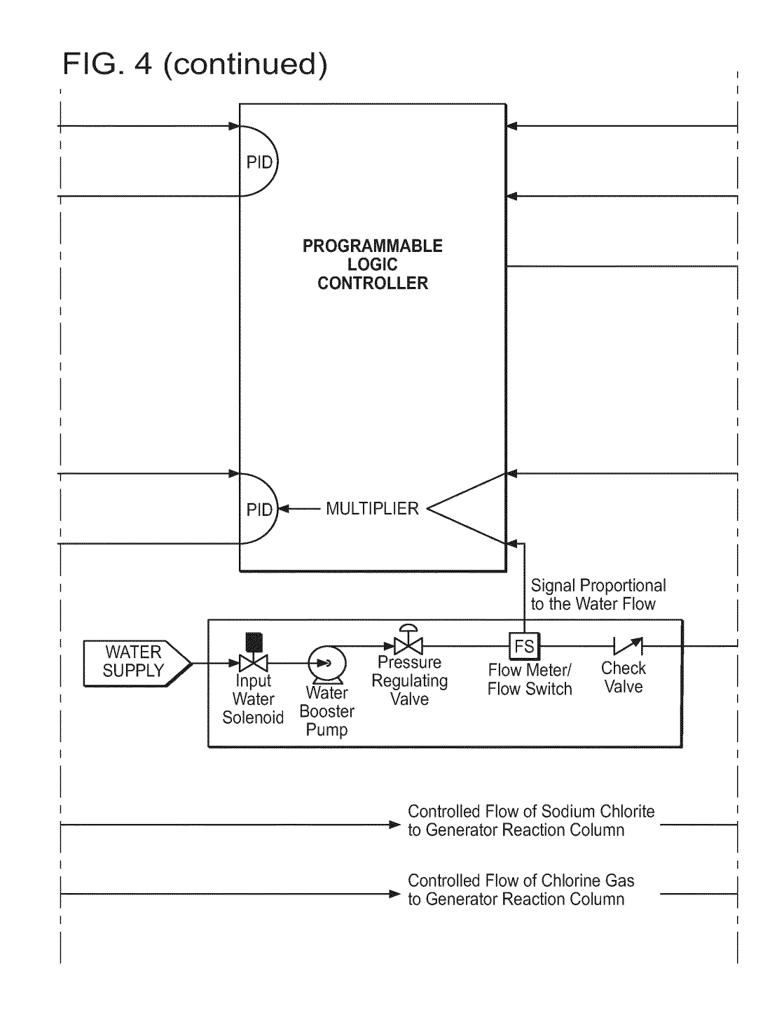

FIG. 4 is a simple process flow diagram for Vulcan Performance Chemicals' new design for an “Automatic” Chlorine Dioxide Generator. The new design generator additional automatic efficiency enhancements supported by an electronic chlorine flowmeter and an optical chlorine dioxide analyzer. The chlorine flowmeter (rotameter) allows for independent and accurate application of the proper amount of chlorine for maximum efficiency. The optical chlorine dioxide analyzer is looped in with the supply water flow meter and the process controller to allow for fine exact adjustment of precursor chemicals and real-time display of efficiency.

In the diagram of FIG. 4, Analog Signal Representing Plant Flow or Locally Adjusted Set Point and Analog Signal Representing Dosage or Locally Adjusted Dosage Set Point are values used by the process controller to calculate the flow rate required for each of the precursor chemicals. Analog Signal Proportional to Concentration from the Calibrated Chlorine Dioxide Optical Analyzer and Analog Signal Proportional to the Water Flow are values used by the process controller to calculate the process variable using independent process parameters.

With further reference to FIG. 4, the electronic chlorine flowmeter enhances efficiency. For example, the process utilized involves the flow of chlorine gas through a device that provides an output signal that is in direct proportion to the actual gas flow. The efficiency enhancement is due to the improvement in accuracy. The process controller uses PID loop control to accurately supply the proper amount of chlorine. Historically, the chlorine flow rate was accomplished with a control valve only. The flow of chlorine was assumed to be linear with valve position, which it is not; therefore, improved efficiency at all production rates.

In operation, the mass dispersion chlorine flowmeter sends a signal to the process controller which in turn adjusts the control valve (to open or close). In this way, the production of chlorine dioxide can be efficiently produced.

Further referring to FIG. 4, the optical chlorine dioxide analyzer analyzes for the yellow-green color of the chlorine dioxide in the aqueous solution, and provides an independent value to the process controller that is used to compute the chlorine dioxide production rate. This value is compared to the chlorine dioxide production rate as calculated from the sodium chlorite flow rate. The resulting comparison provides verification of efficiency, or uses a PID loop involving the optical analyzer, the chlorine control valve and the process controller to increase the efficiency to the desired level. This automated efficiency feature guarantees the quality of the chlorine dioxide produced. In the event optimum chlorine dioxide is not being produced, the process controller will make the following adjustments: (1) open the chlorine valve incrementally, (2) observe any change in efficiency, (3) repeat until acceptable, and (4) if an increase in chlorine gas flow does not improve the efficiency, the controller will close the chlorine valve incrementally until the efficiency improves to the desired level.

FIG. 5, “Prior Design” vs. “New Design”, there are fewer parts and different placement of components. Wet end improvements are shown the significant “wet end” improvements involve dramatic simplification along with a very significant reduction in the number of parts that require periodic service. The chlorine dioxide generation system provides for a dramatic reduction in the number and type of seals that require (excessive) maintenance. Common practice has been to use Viton™ seals in all areas of the equipment. Viton is known to have a limited service life with some chemicals encountered in the generation process. In the new design-emphasis has been placed on the elimination of seals where possible. A most significant innovation has been the development of a seal-less eductor. Where seals exist, a more resistant material has been selected. New designs were incorporated: (1) in the ejector—reducing the seals from 3 to 0, (2) seal-less tubing connectors, (3) seal-less manual flow meters (rotameters), and (4) simplified design reduced the number of union-type fittings. Actual experience in the past year have borne this out. Maintenance issues have been minimized. In addition, the overall cost of the wet end components is significantly lower. Mechanical flow meters (rotameters) of the new design have no seal maintenance issues whereas the prior flow meters have 5 O-Ring seals that require replacement at least each 6 months. Simplified design has reduced the number of unions (each with 1 O-Ring) to 1 from 6. A clear section of schedule 80 PVC has replace a sight tube and its 2 O-Rings. Automatic unit control valves and flow meters are positioned on a stainless steel rack at approximately waist height. This makes working with those components less difficult. The prior designs required kneeling, or even lying down to reach low components, that were often enclosed in dark places. In FIG. 5 exemplary of the board-size on which the components are placed is 27 inches wide and 37 inches high. These measurements could be varied as understood by those skilled in the art.

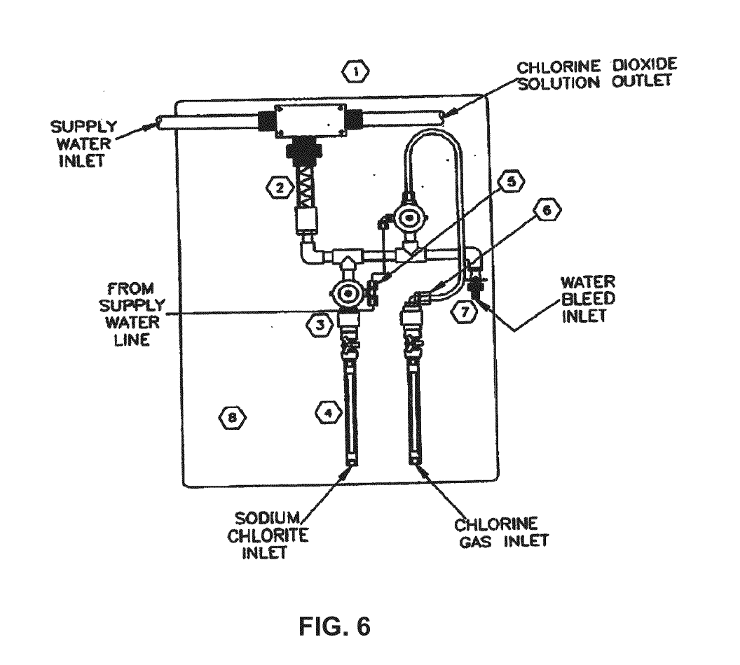

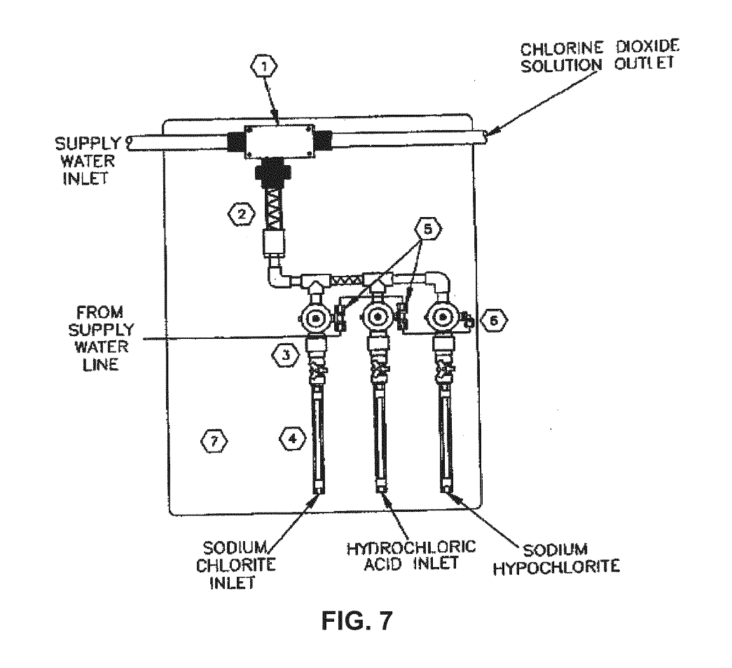

FIGS. 6 and 7 compare the components of the new design two-chemical chlorine dioxide generator and the three-chemical chlorine dioxide generator, respectively.

The numbers in FIG. 6 describe
1. Ejector
2. Reaction column/chemical inlet assembly
3. Check valve/metering valve assembly (2)
4. Chemical rotameters (3)
5. ⅛″ MPT×⅛″ hose tee tubing connector
6. ⅛″ MPT×⅛″ hose elbow tubing connector
7. Water bleed inlet valve
8. Fiberglass backboard.
   and the numbers in FIG. 7 describe
1. Ejector
2. Reaction column/chemical inlet assembly
3. Check valve/metering valve assembly (3)
4. Chemical rotameters (3)
5. ⅛″ MPT×⅛″ hose tee tubing connector (2)
6. ⅛″ MPT×⅛″ hose elbow tubing connector
7. Fiberglass panel with feet.

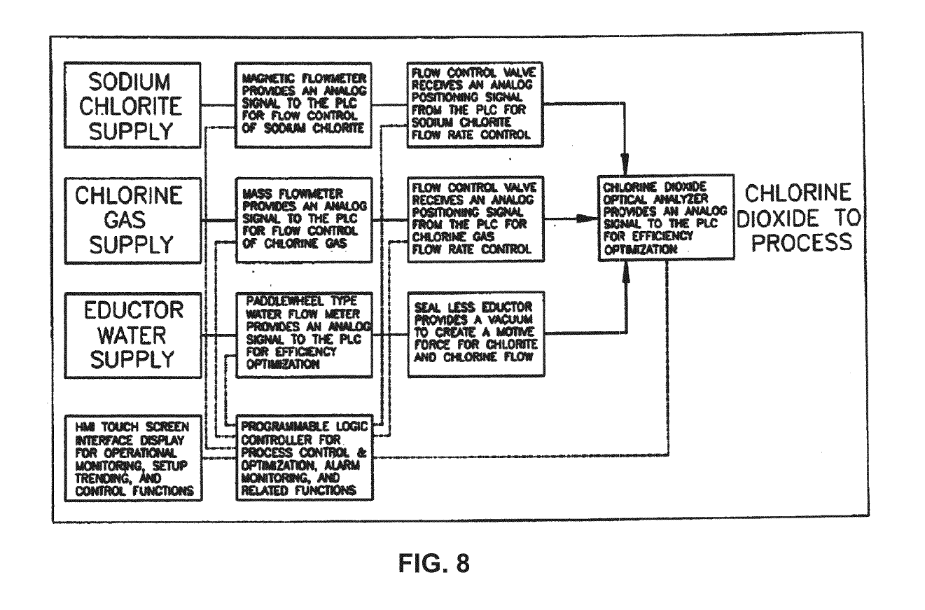

FIG. 8 is a flow-diagram of chlorine dioxide production using sodium chlorite, chlorine gas and eductor water supply. The programmable logic controller controls the amount of chemicals fed into the system by analyzing the amount of chlorine dioxide produced. The amounts of chemical fed into the system is controlled by a flowmeter which in turn is controlled by the programmable logic controller. A seal-less eductor provides vacuum. A touch screen is incorporated into the system to monitor and adjust for real-time conditions.

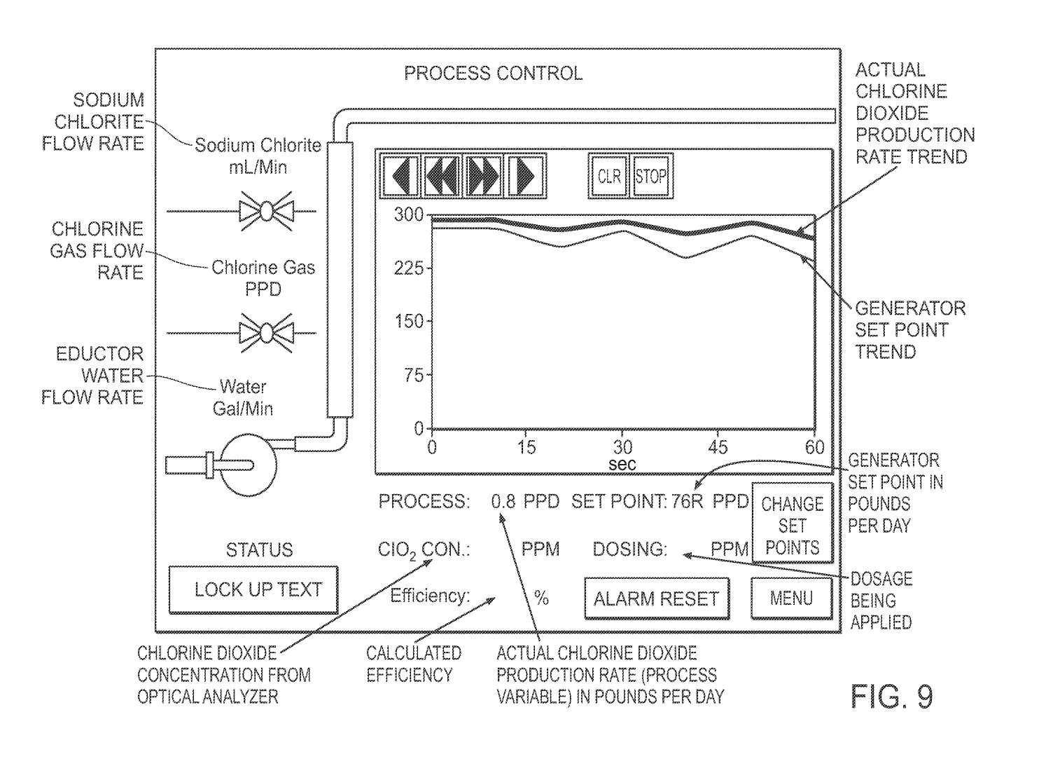

FIG. 9 is an illustration of the touch screen employed in this invention. The touch screen is a full 10.4 inches in size. This display provides an overall “look” at what is happening in the chlorine dioxide generation process. The operator can see the sodium chlorite flow rate, chlorine flow rate, and other relevant parameters such as chlorine dioxide concentration all on one screen. In addition, the operator can observe the trends for set point and process variable on the same display. This is important to quickly observe system stability, both in the set point (from a remote signal) and the corresponding process variable (how much chlorine dioxide actually being produced.

Further, the touch screen interface display used in this invention provides immediate access to information and control by “touching” the appropriate location displayed on the screen itself, much as self-service gasoline is often dispensed. The operator “makes a selection” which allows for a specific response or entry to be made. This could involve changing the generator set point, changing the input from local to remote control, setting up initial meter span parameters, and virtually any other operating function required. For example, if the operator sees a “no chlorite” alarm, he can investigate the cause and solve the problem; or another example, if the operator needs to change the dosage, he can go to the dosage screen and make the adjustment by entering the desired dosage.

In further explanation of the operation of the touch screen of FIG. 9:

An actual Chlorine Dioxide Production Rate Trend is used to evaluate system stability and observe changes.

The Generator Set Point Trend is used to observe input signal changes.

Dosage being applied is the actual pounds of chlorine dioxide per million pounds of water that it is being applied.

Generator Set Point in pounds per day is the set point for the amount of chlorine dioxide that the generator is scheduled to produce.

Actual Chlorine Dioxide Production Rate (Process Variable) in pounds per day is the actual amount of chlorine dioxide produced relative to the theoretical.

Calculated Efficiency is measured by stoichiometric amount, e.g., conversion sodium chlorite to chlorine dioxide.

Examples of set points which could be changed are dosage, ClO₂ set points.

An example of the use of the alarm reset is when a chemical day tank goes empty and is then refilled. The alarm would have to be reset.

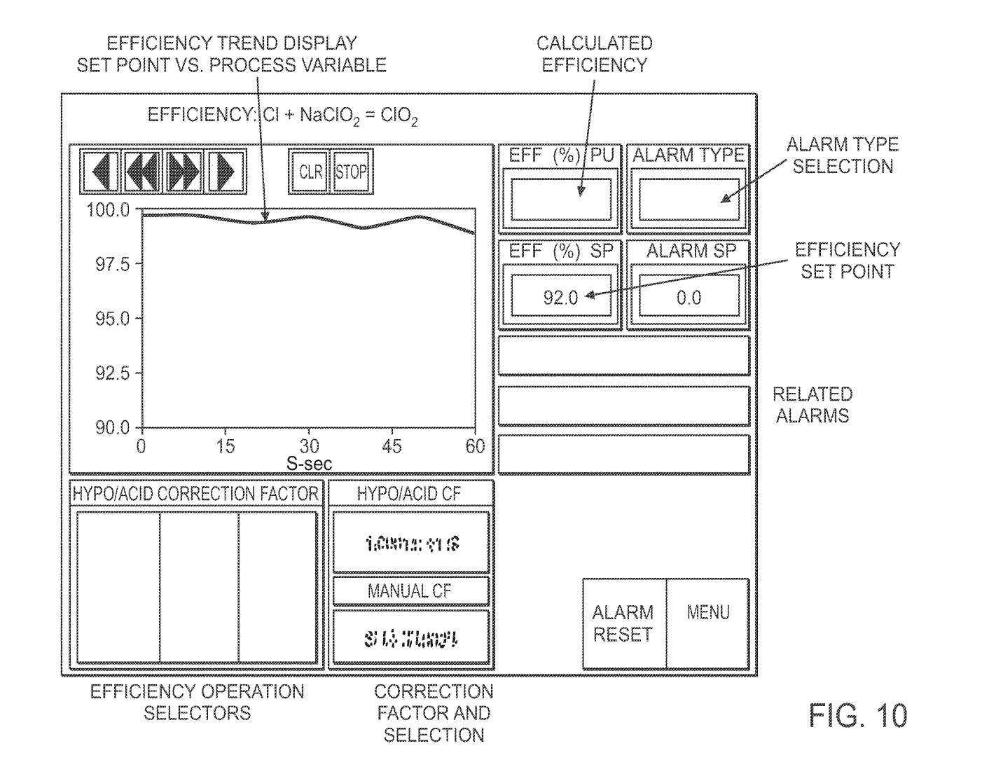

FIG. 10 is an illustration of the automatic efficiency control screen employed in this invention. This display provides setup and monitoring for automatic efficiency control. The operator can set the range of efficiency control desired (usually above 95%) and provide for an alarm feature if the actual efficiency deviates from entered ranges. The operator can also turn the automatic efficiency feature “on”, “off” or to “manual”. The manual feature allows for the operator to intentionally add excess chlorine if a specific need requires it. As with the process control screen, the efficiency set point and process variable are displayed on a trend display for a quick observation of system stability.

In further explanation of the operation of the automatic efficiency control screen of FIG. 10, the Efficiency Trend Display has the following features:

Set Point vs. Process Variable is employed to observe system stability and changes.

Calculated Efficiency is used to automatically tune the generator.

Alarm Type Selection is used to determine if efficiency control is important or not. If not critical, the alarm will occur but the unit will continue to operate.

Related alarms are optical analyzer failure—(lamp failure).

Correction Factor and Selection is used for control of efficiency feature. Some applications may want to manually apply excess chlorine.

OP TEK System Failure/Off Alarm is an alarm indicating the optical analyzer is malfunctioning.

PV over-range and PV under-range are signals to gauge efficiency. If the efficiency set point is 95%, over-range would be >100%; under-range <90% if the alarm is set for ±5%.

The primary use for automatic efficiency operation is to set up the control. For example, when “Auto” is selected, self-tuning occurs. When “(off) reset to 1.0” is selected, the auto efficiency feature is disabled. When “Manual” is selected, the operator can bias the chlorine feed by the amount entered as “Manual Cf.”; >1.0=more chlorine: <1.0=less chlorine.

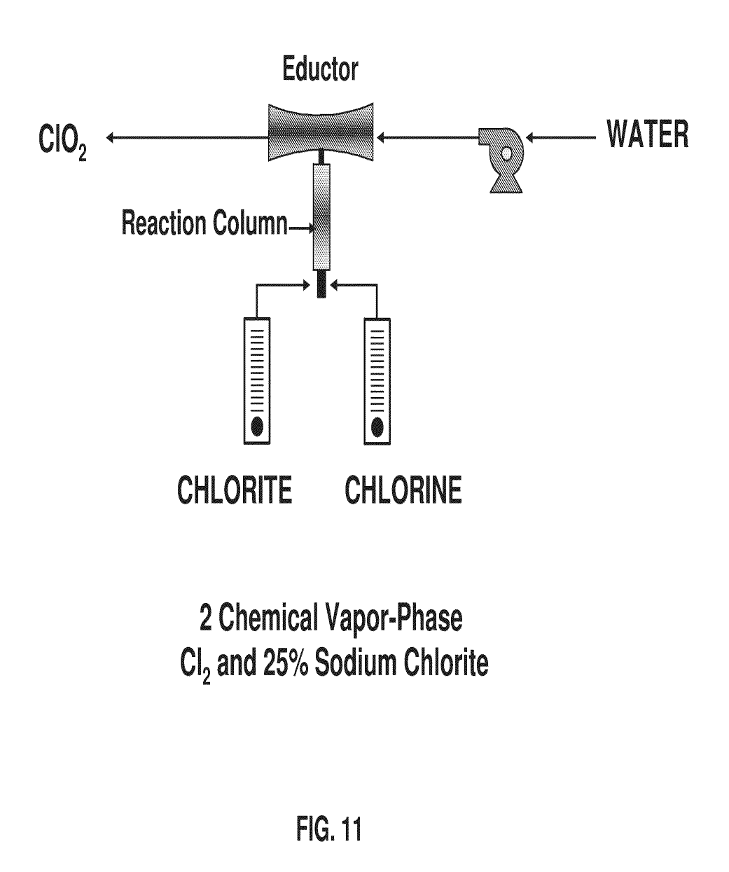

FIG. 11 presents a schematic of a two-chemical reactant version of systems in accordance with one or more embodiments. In some non-limiting embodiments, the sodium chlorite can be an aqueous solution composed of 7.5%, 15%, 25%, or 31% by wt. sodium chlorite. The two chemical sodium chlorite/chlorine gas method is highly efficient. In some embodiments, theoretically 2 moles sodium chlorite goes to two moles chlorine dioxide with a theoretical molar conversion efficiency of 100% and a reaction yield of 100%. 95 to 98% conversion efficiency and yield may be obtained.

This is a true molecular chlorine reaction with chlorite that occurs in milli-seconds under vapor phase vacuum conditions. Vacuum may be created by a motive stream of water driving a vacuum eductor that serves also to pull in the chlorine gas and chlorite solution through rotameters and/or a combination of auto metering control valves and rotameters. This allows the reactants to be fed to the reaction column in a very precise ratio. The rotameters can be controlled manually by setting the rotameters at the proper setting for the precise feed ratio required, or the feed rates of the reactants can be controlled automatically using the auto metering control valves interconnected with a PLC via a PID electronic loop. Special programming may be contained within the PLC to maintain proper feed rates of the reactants.

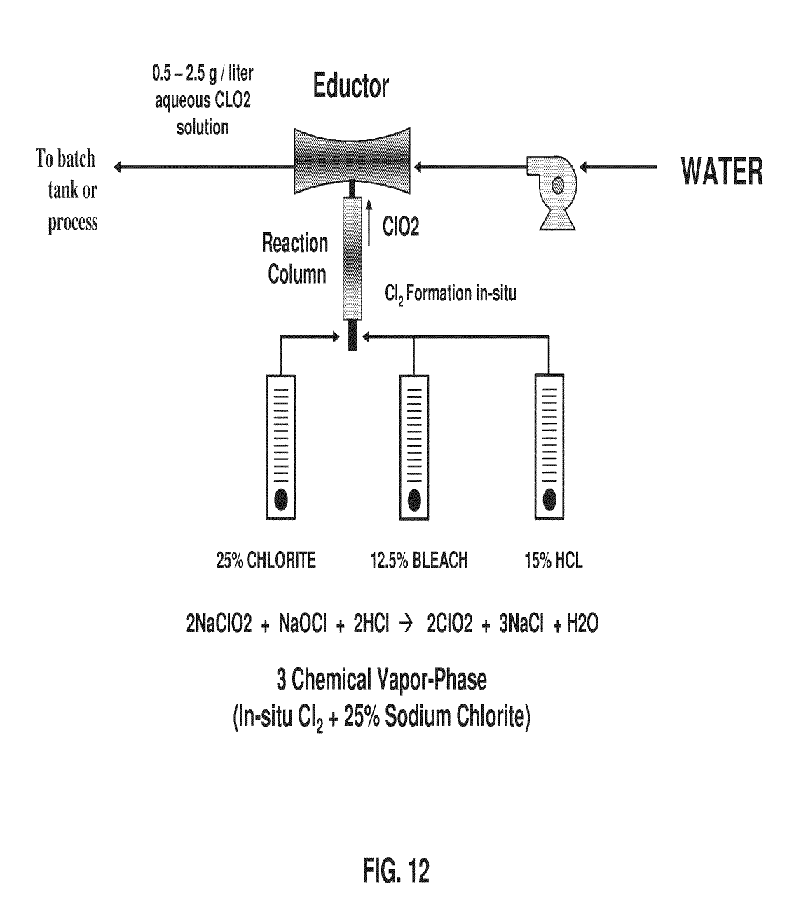

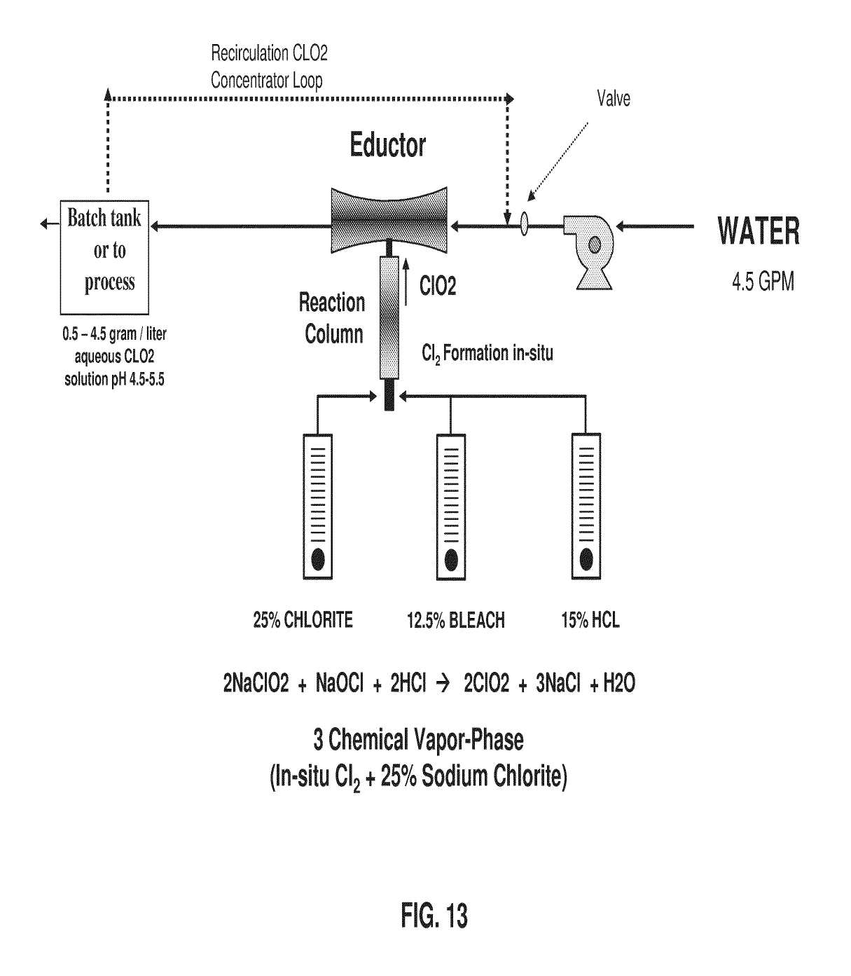

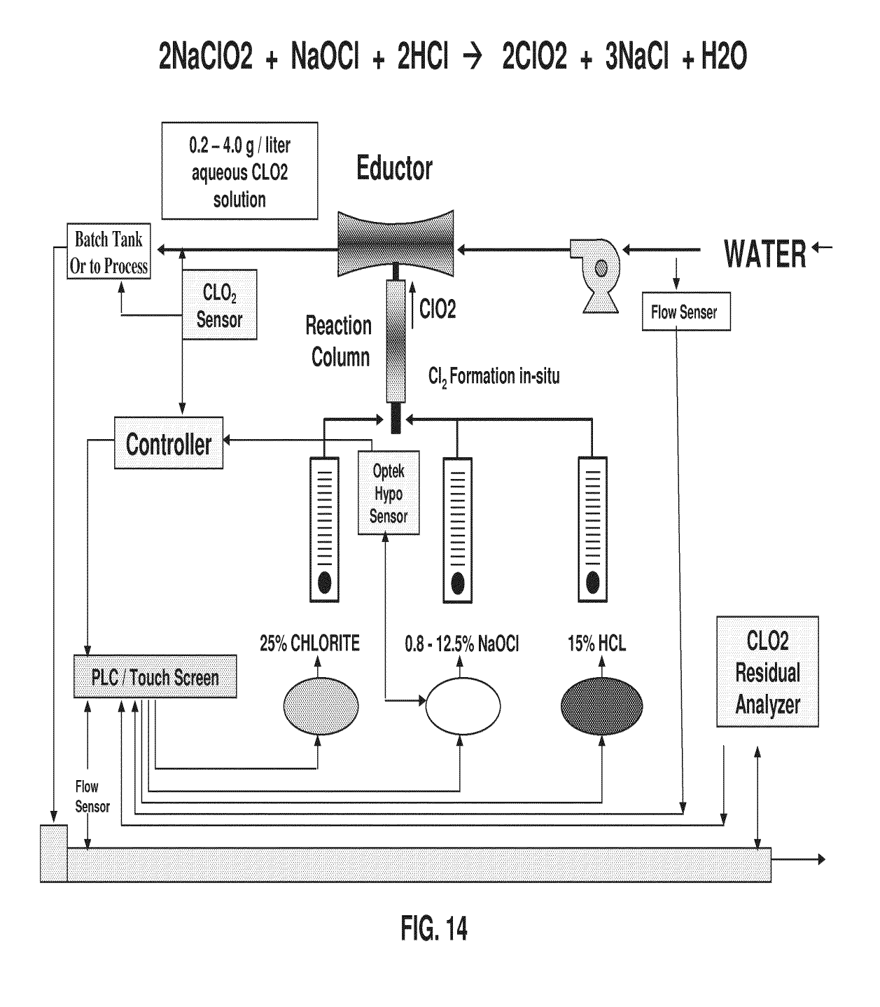

FIGS. 12-14 present schematics of three-chemical reactant versions of chlorine dioxide generation systems in accordance with one or more embodiments. The reactants may include sodium chlorite, hydrochloric acid and sodium hypochlorite. In some non-limiting embodiments, 12.5% sodium hypochlorite is fed and reacted instantaneously with 15% HCL just ahead of the vacuum based reaction column to produce chlorine in-situ (just ahead of the sodium chlorite injection) with the in-situ chlorine reacting instantaneously as formed with the sodium chlorite to produce chlorine dioxide. Each of these two reaction mechanisms/processes are highly efficient in respect to the molar conversion efficiency from sodium chlorite to chlorine dioxide. The in-situ production of chlorine may avoid handling and storage of chlorine gas.

In some non-limiting embodiments, a three-reactant system is designed to operate using 12.5% by wt. sodium hypochlorite reacted in a precise and constant proportional ratio with 15% hydrochloric acid and 25% (or 31%) by wt. sodium chlorite. Such systems may deliver a minimum 95% yield and minimum 95% molar conversion efficiency from sodium chlorite to chlorine dioxide, when using 12.5% bleach, 15% HCL and sodium chlorite. The typical conversion efficiency and yield are each 95-99%.

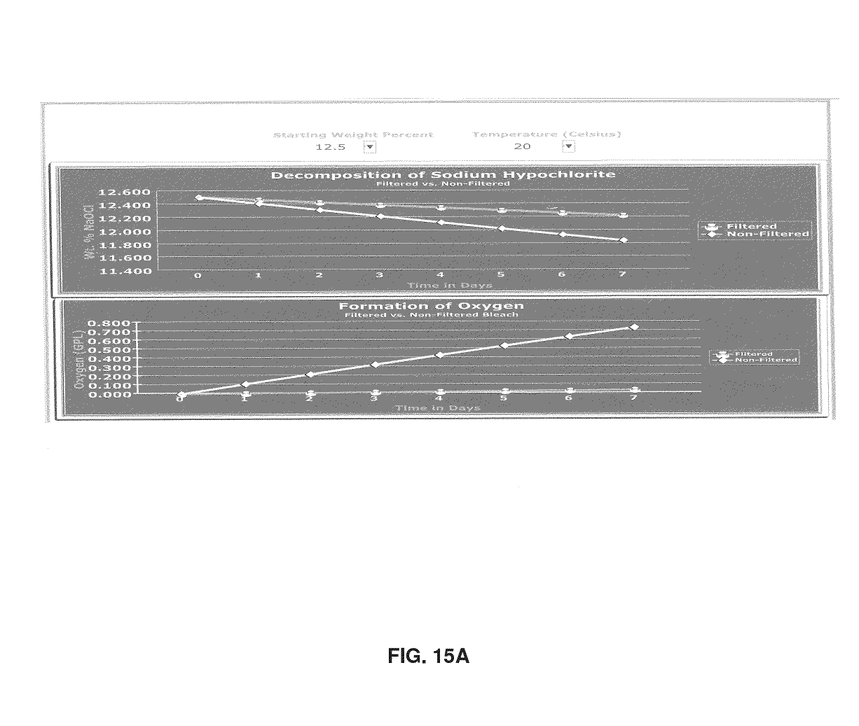

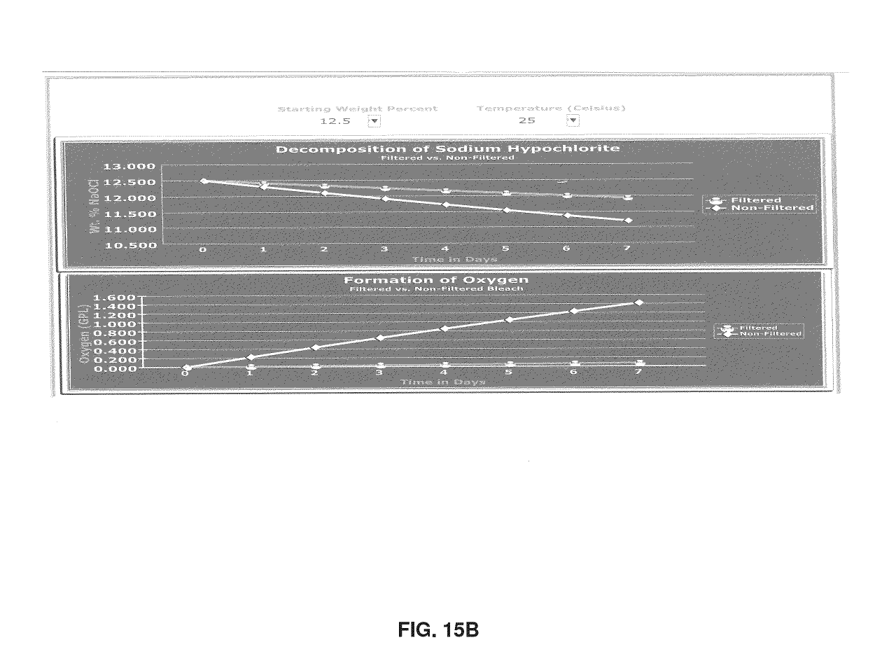

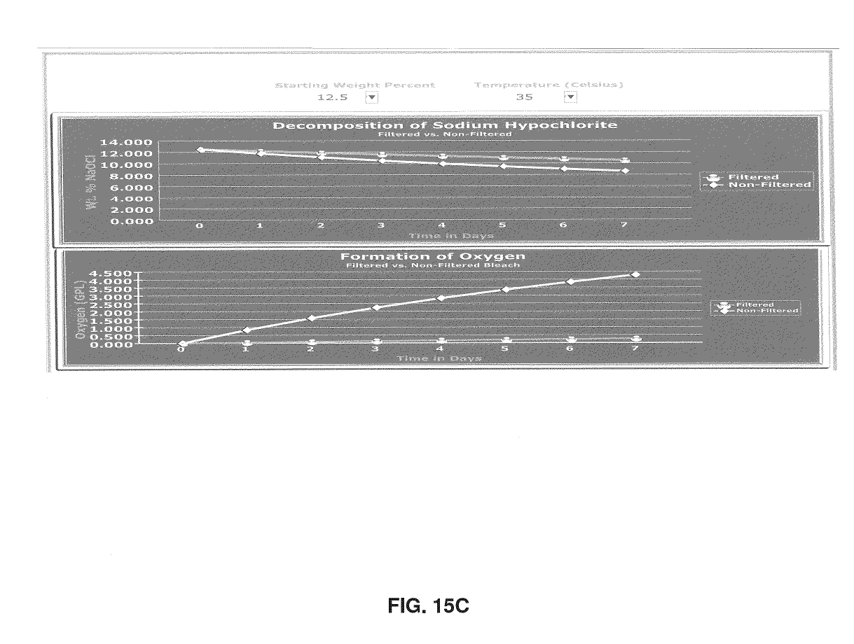

While some reactants, such as hydrochloric acid and aqueous sodium chlorite are generally shelf-life stable, sodium hypochlorite may degrade over time as evidenced by the data presented in FIGS. 15A-15C. These bleach degradation charts show degradation of filtered versus unfiltered commercial 12.5% bleach versus temperature versus time. As a result of degradation, less chlorine may be produced, the reaction ratios may suffer, an overfeed of chlorite can occur, and the overall reaction ratios/reaction efficiency/chlorine dioxide production rate can suffer and this can also increase undesired reaction by-products (salts, oxygen, chlorite, chlorate) in the chlorine dioxide being produced due to side reactions occurring. A less pure aqueous chlorine dioxide stream delivered to the use point may result.

In the three chemical process described above, sodium hypochlorite reactant may constantly degrade over time. In accordance with one or more embodiments, the systems and methods may account for the degradation. In some embodiments, feed rates of the bleach (sodium hypochlorite) and/or reaction ratios may be adjusted to compensate for the reduced strength of the bleach.

In accordance with one or more embodiments, one or more sensors may be incorporated to detect, measure and/or monitor the concentration of one or more reactants. A sensor may be positioned along a reactant feed line. In some embodiments, the sensor may be an optical analyzer. In at least one embodiment, the concentration of sodium hypochlorite may be measured by the sensor. The sensor may measure the reactant concentration continuously or intermittently. The monitoring may provide information, such as real time information, to a controller. The controller may include a program configured to make automatic adjustments to reactant flow rate based on the concentration data supplied by the sensor to optimize chlorine dioxide generation. For example, in one non-limiting embodiment involving three-reactants, a hypo analyzer may be positioned along the sodium hypochlorite feed line and provide information to the PLC program which can adjust the sodium hypochlorite valve position in response to concentration variations. In some embodiments, a relationship between reactant concentration and reactant flow rate may be established to facilitate control of valve position.

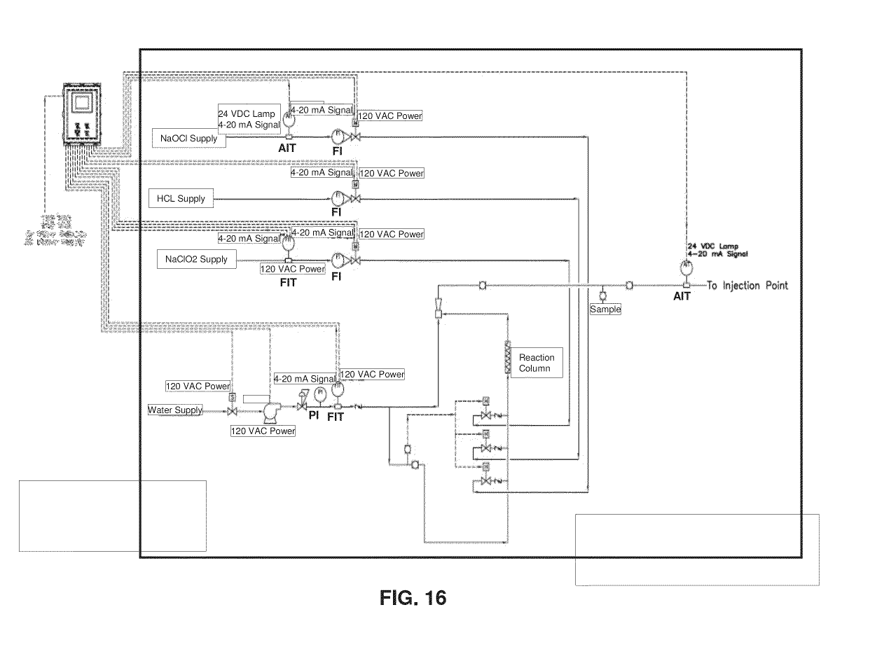

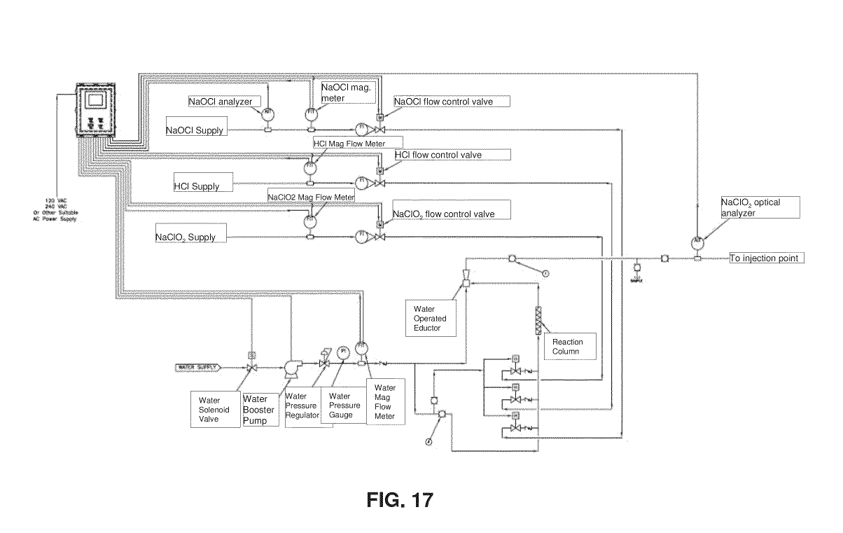

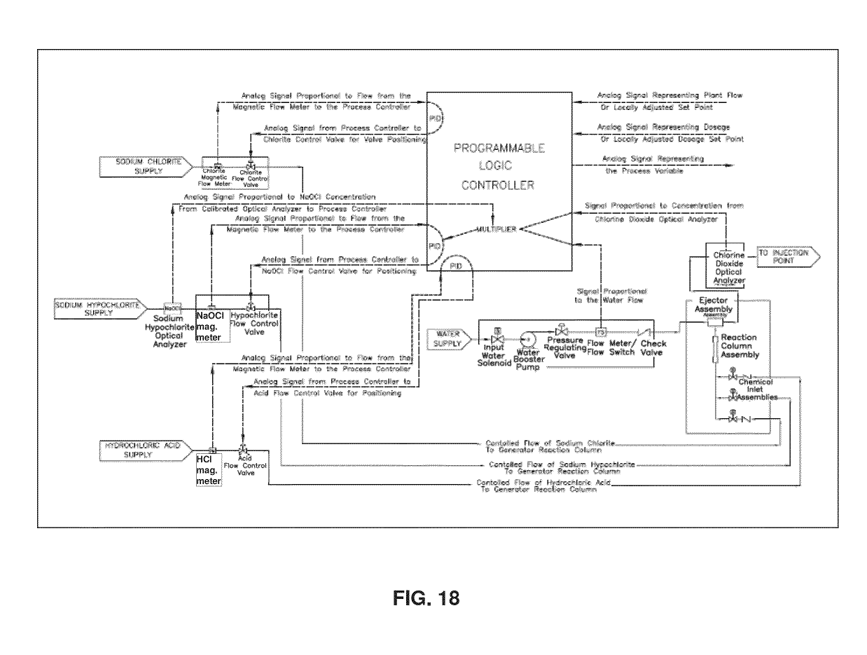

In accordance with one or more embodiments, in-line real time optical sensors may be used in conjunction with a controller capable of sending an electronic signal to the system's PLC, so as to monitor the real time concentration of bleach that is being fed to the reaction column and to simultaneously allow and control an automatic flow/feed adjustment, for example, via PLC interaction with an auto metering control valve, of the bleach feed rate that is fed to the reaction column. The precise stoichiometric bleach feed ratio based on its actual strength with the acid feed and chlorite feed rates required to be fed to the generator's reaction column may be automatically adjusted and maintained in real time to maintain optimum reaction efficiency, yields and high conversion efficiency. FIG. 16 presents a piping and instrumentation diagram in accordance with one or more embodiments. FIG. 17 presents a process flow diagram providing a detailed view of the boxed region of FIG. 16. FIG. 18 presents a PLC schematic in accordance with one or more embodiments.

In accordance with one or more embodiments, the in-line real time measurement of bleach concentration further allows the PLC/PID Loop/programming interface to automatically adjust, increase or decrease, either or both the bleach and acid feed rates above the stoichiometric required ratio, while holding the chlorite feed rate constant, thus allowing the system to produce chorine in excess, which thus allows for the delivery a mixed oxidant stream containing a synergistic mixture of chlorine dioxide and chlorine in various ratios. This may provide synergistic benefits when treating potable water, wastewater, cooling water and any other water stream or process air or water treatment requiring oxidation and/or disinfection.

For example, it may be desirable to dose a water stream or process stream, such as one involving potable water, wastewater, cooling tower water, white-water biocide, industrial water from paper machines or bleaching processes, water, air stream or hydrocarbon containing stream in an environmental treatment application, with either high purity chlorine dioxide containing very little to no excess measureable chlorine or bleach. In other embodiments it may be desirable to dose the process stream with a co-produced mixture of chlorine dioxide and a defined amount of excess chlorine, the concentrations of which can be dialed in via the PLC control system interface.

In accordance with one or more embodiments, an optical analyzer or sensor may monitor chlorine dioxide strength produced by the generator, while an optical hypochlorite sensor may be used simultaneously to monitor and automatically control bleach feed. The real time strength of bleach fed to the generator's reaction column may be monitored. The optical hypochlorite sensor may interface with the PLC via electronic signal for control of the bleach feed in accordance with one or more embodiments. Vacuum may be used to meter the various reagents through auto metering control valves. In some non-limiting embodiments, LVN 2000 or Omni Hydro metering valves may be used.

In accordance with various embodiments, one or more sensors may be incorporated to detect, measure and/or monitor the concentration of a reactant other than, or in addition to, sodium hypochlorite. For example, a sensor may be positioned along a sodium chlorite reactant feed line. In some embodiments, the sensor may be an optical analyzer. In at least one embodiment, the concentration of sodium chlorite supplied to a reaction column may be measured by the sensor. The sensor may measure the reactant concentration continuously or intermittently. The monitoring may provide information, such as real time information, to a controller. The controller may include a program configured to make automatic adjustments to reactant flow rate based on the concentration data supplied by the sensor to optimize chlorine dioxide generation. For example, in non-limiting embodiments involving two or three reactants, a sensor may be positioned along a sodium chlorite feed line and provide information to the PLC program which can adjust the sodium chlorite valve position in response to concentration variations. In some embodiments, a relationship between reactant concentration and reactant flow rate may be established to facilitate control of valve position. In at least one embodiment, a sensor configured to detect sodium chlorite concentration and a sensor configured to detect sodium hypochlorite concentration may both be in communication with a process controller for improved efficiency with respect to chlorine dioxide generation.

In accordance with one or more embodiments involving the monitoring of reactant concentration, an amount of light absorbed may be related to a concentration of an absorbing molecule. In some embodiments, the absorbing molecule may be chlorite and/or hypochlorite. A spectrophotometer analyzer, such as those commercially available from optek-Danulat, Inc. or Hach Company, may be used as a concentration sensor. In some specific embodiments, the spectrophotometer analyzer may be configured for double beam scanning. Absorbance measurements may be used to measure reactant concentration in different ways, such as by using absorption coefficients or calibration curves. In accordance with various embodiments, a correlation factor may generally be derived between absorbance and reactant concentration that can be used to determine the concentration of a specific absorbing species in a measured sample.

In accordance with one or more embodiments, a correlation curve may be developed based on measurements taken at various wavelengths. A peak may then be selected with little known interference or absorption overlap of other chemical species upon which to base absorption readings. For example, a spectrum of about 225 nm to about 600 nm may be evaluated. At each wavelength, the intensity of light passing through a blank fluid, such as water, of known path length may be measured. The intensity of light passing through a reagent feed sample may be measured using the same path length and materials of construction. Transmittance and absorbance may then both be calculated, manually or automatically by the analyzer. Absorbance may then be correlated to the concentration of the reagent via calibration curve and PLC programming. Based on the absorbance curves, a proper wavelength for measuring the reagent concentration may be selected. For chlorite, non-limiting examples of wavelengths may be 235 nm, 360 nm, 450 nm, 500 nm or 550 nm. Since chlorite solutions are relatively constant as to inert concentrations, and the inerts (e.g. chloride) have relatively low absorbtivity, one would generally not expect interference in typical reagent grade sodium chlorite at various concentrations, for example, commercially available 7.5%, 15%, 25%, 31% or greater sodium chlorite.

With particular reference to some non-limiting embodiments involving the monitoring of sodium chlorite concentration, a first absorbtivity curve versus sodium chlorite strength from 23.5% to 26.5% may be developed for 25% sodium chlorite, as well as a second absorbtivity curve versus sodium chlorite strength from 29.5% to 32.5% for 31% sodium chlorite. A formula may then be programmed into the controller of a chlorine dioxide generator to calculate actual sodium chlorite strength based on absorbtivity measured at a certain selected nanometer wavelength. In some embodiments, manual titration data may be compared for validation of the absorption curve.

The most costly component of ongoing operating costs associated with a chlorine dioxide generation program is generally recognized to be the sodium chlorite required to produce one pound of chlorine dioxide. In any chlorite and/or chlorate based chlorine dioxide generation process, the amount of chlorine dioxide produced and extracted from each pound of sodium chlorite or sodium chlorate fed to the generator's reaction column should be maximized.

Due to variations in sodium chlorite strength received and in storage, coupled with the difficulty in measuring its concentration in near real time, the maximum expected efficiency of sodium chlorite molar conversion to chlorine dioxide in a conventional chlorine dioxide generator is at best 95% molar conversion of the reactants to products. The theoretical maximum molar conversion efficiency is 100% if the required reactants are fed in the correct molar ratio. In accordance with one or more embodiments, the concentration of reactant, such as sodium chlorite and/or sodium hypochlorite, may be monitored in real time as the reactant is fed to a chlorine dioxide generator, such as via a magnetic flow meter and/or an auto metering control valve. The flow rate of reactant may be adjusted to compensate for the actual reactant concentration being supplied to the reaction column. The ability to adjust a sodium chlorite feed rate based on real time strength and in the correct proportional ratio to other starting co-reactants in real time may beneficially lower the cost of disinfection and chlorine dioxide in general due to enhanced efficiency. The propensity for reaction imbalance and the production of undesired and/or unreacted byproducts in the produced chlorine dioxide stream may also beneficially be reduced. In accordance with one or more embodiments of the disclosed systems and methods, a molar conversion efficiency of from about 95% to 97% or more may be achieved.

In accordance with one or more embodiments, two and three chemical reaction systems may be tuned to achieve at least 95% molar conversion efficiency and chlorine dioxide yield based on precise control of the chemical reactant ratios fed to the generator's reaction column. In various embodiments, the systems and methods may be further optimized using real time sensors that measure and monitor the actual chlorine dioxide concentration exiting the generator. Input from the reactant and product concentration sensors may be compared within a PLC program to what can be produced theoretically at 100% conversion efficiency and 100% reaction yield based on the theoretical chemical reaction stoichiometry. This comparison between theoretical and actual production may be used to optimize the chlorine dioxide strength being produced using PLC controlled auto tuned adjustment of auto metering control valves that feed one or more reactants to the reaction column. For example, proportional feed volumes of hypochlorite, acid, (or chlorine) and chlorite to the reaction column may be adjusted to improve efficiency. With respect to sodium hypochlorite, adjustment may be based on real time measured hypochlorite strength (for example, 0.6% to 13% strength) that is fed to the generator's reaction column using an in-line optical analyzer.

With respect to sodium chlorite, the actual concentration of commercially available reactant generally deviates more or less in terms of indicated weight strength, for example, 25%. Since the process chemistry and correct theoretical proportional feed ratios are based on an assumption regarding sodium chlorite feed concentration, this assumption can automatically create an incorrect proportional feed ratio for the reagents plus some pH imbalance, thereby resulting in a lower conversion efficiency and lower reaction yield to chlorine dioxide versus theoretical maximum possible. This imbalance may also increase the propensity for competing unwanted by-product formation that lead to greater chlorate and unreacted chlorite concentrations thru competing side reactions that can lower the conversion efficiency, yield and purity of the produced chlorine dioxide aqueous solution. In accordance with one or more embodiments, reagent ratio adjustments may be made based on actual consideration of the true reactant strength, such as that of sodium chlorite and/or sodium hypochlorite, through an in-line spectrophotometric approach. At certain wavelengths, the molar absorptivity of sodium chlorite in water may be used for measuring sodium chlorite reactant concentration accurately while avoiding interfering complexes. An inline device may allow for real time reactant ratio compensation in view of an assumption error that may otherwise impact the reagent feed ratios as well as the theoretical possible conversion efficiency and yield.

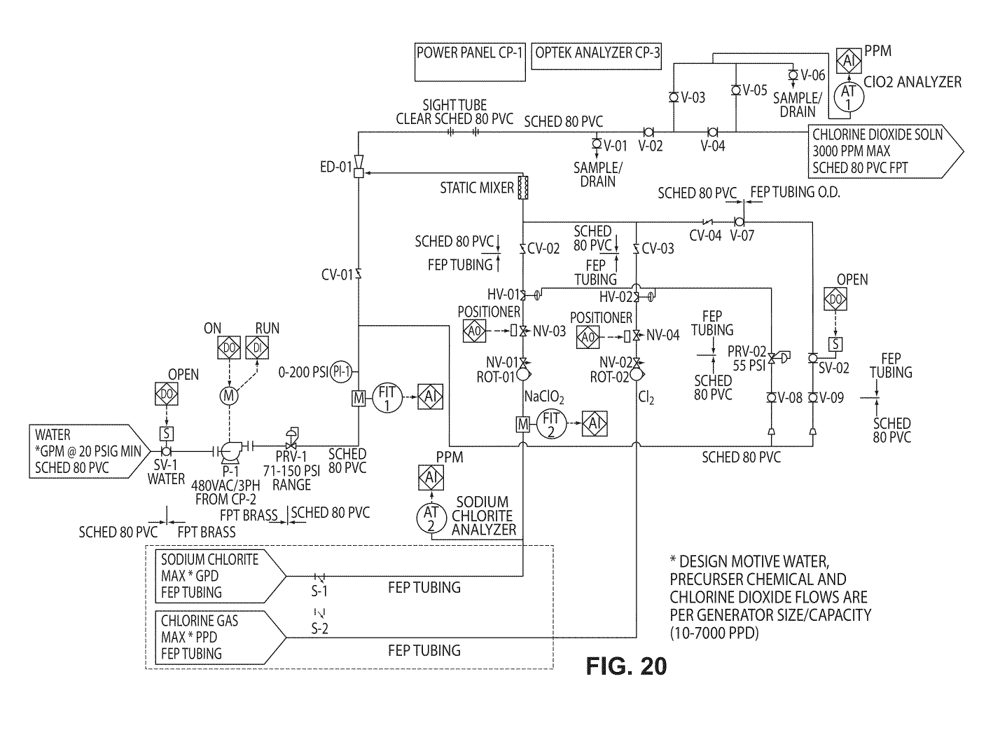

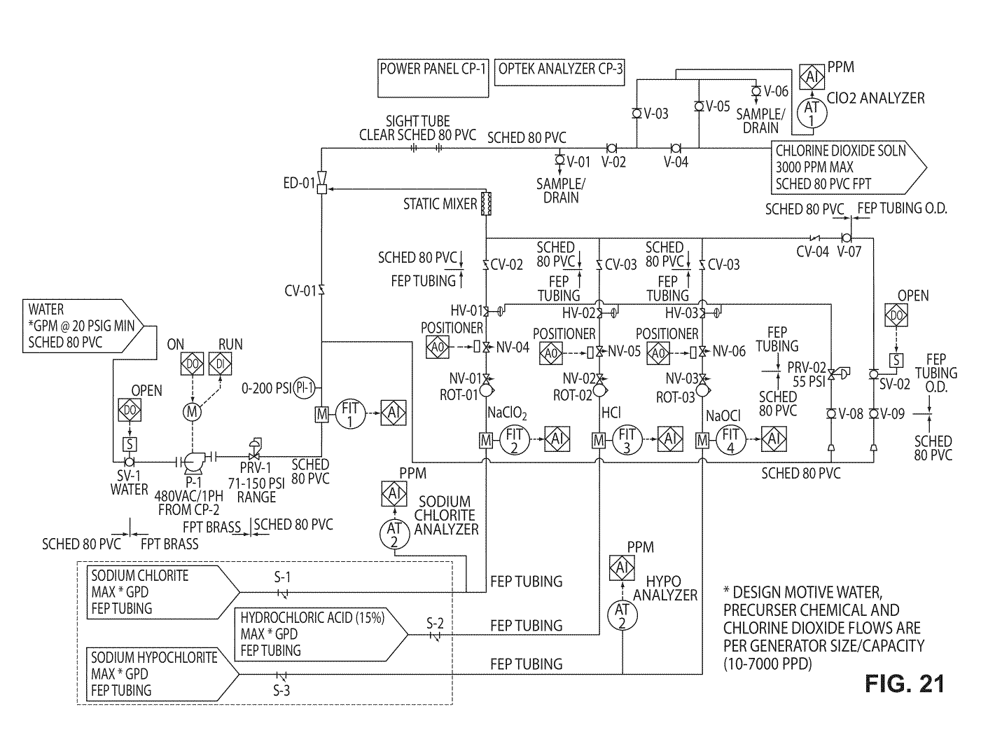

In accordance with one or more embodiments involving two reactants, for example, sodium chlorite and chlorine, a concentration of at least one of the reactants may be monitored as discussed above. FIG. 20 presents a P&ID for a two-reactant system in accordance with one or more embodiments in which the concentration of sodium chlorite is monitored with an analyzer. In accordance with one or more embodiments involving three reactants, for example, sodium chlorite, sodium hypochlorite, and hydrochloric acid, a concentration of at least one of the reactants may be monitored as discussed above. FIG. 21 presents a P&ID for a three-reactant system in accordance with one or more embodiments in which the concentration of sodium chlorite and the concentration of sodium hypochlorite are both monitored with separate analyzers.

In accordance with one or more embodiments, the strength of a reactant, such as sodium chlorite, may be measured in real time, such as by using an optical analyzer. The feed of the reactant may be adjusted based on its actual real time strength in the correct proportion to the strength of other reagent(s) which may also be measured in real time such as by using additional optical analyzer sensors. The controller may make auto tuning adjustments to maximize efficiency and reaction yield, as well as calculate and display conversion and yield efficiency.

In accordance with one or more embodiments, each reagent feed line may have an associated magmeter. Each reagent feed line may also have an associated rotameter, such as downstream of a magmeter. In embodiments where there is a magmeter followed by a rotameter, there may be a fine tuning auto metering control valve on the reagent feed line. In embodiments where there is a magmeter but no rotameter, there may be an auto fine tuning control valve on the reagent feed line. Signals from one or more optical analyzers associated with reagent feed lines may interface with a controller. The controller may also interface with other components such as magmeters and auto metering control valves via electronic signals. A magmeter or flow meter on a motive water stream driving a generator eductor may also be interfaced with the controller in accordance with some embodiments.

In accordance with one or more embodiments, control valves, such as those including magnetic flow meters, may be associated with one or more reactant feed lines. For example, a system may include one or more magnetic flow meters associated with one or more of the sodium chlorite, sodium hypochlorite and hydrochloric acid supplies. The magnetic flow meters may be in communication with the PLC and receive control signals from the PLC for adjustment of reactant feed. In turn, the PLC may receive input from one or more of the sodium hypochlorite optical analyzer and the chlorine dioxide optical analyzer to monitor the process efficiency and determine what adjustments may be necessary.

In accordance with one or more embodiments, using the three chemical method or two chemical method, a mixed stream of oxidants such as one containing chlorine dioxide and chlorine, in a stream exiting the generator may be dialed-in to the PLC with the actual real time strength of the bleach being detected. Bleach and acid in the proper stoichiometric ratio yields chlorine and optionally hypochlorus acid which then reacts instantaneously under vacuum with chlorite to produce chlorine dioxide in a high efficiency reaction that occurs on a stoichiometric basis. By pre-reacting bleach with excess acid, before chlorite is introduced, chlorine may be produced in-situ. In some embodiments, 2 moles of chlorine gas may react with 2 moles of chlorite to yield 2 moles of chlorine dioxide. If more bleach and more acid is fed to produce chlorine in excess of the stoichiometric chlorite requirement, a mixed aqueous oxidant stream of chlorine dioxide plus excess chlorine may be produced exiting the generator, such as to treat water.

In accordance with one or more embodiments, the chlorine dioxide and chlorine mixture may be produced under vacuum before dilution in the water that is driving the vacuum eductor associated with the generator. This mixture may be ejected as it is formed to the water stream and exit the generator in the form of a mixed aqueous chlorine dioxide and chlorine oxidant feed stream that is fed automatically to downstream application points. As excess molecular chlorine created in the reaction column dissolves in the eductor motive water dilution stream, the excess chlorine may form hypochlorus acid which is a strong disinfectant. The combination of chlorine dioxide, chlorine and hypochlorus acid is synergistic as to microbiological control and disinfection. The reaction of chlorine dioxide to oxidize humic and fulvic acids is kinetically fast such that the simultaneous addition of chlorine dioxide with chlorine and hypochlorus acid avoids THM and THAA formation, which is regulated at maximum MCL limits. If chlorine and hypochlorus acid were to added ahead of chlorine dioxide or singly without chlorine dioxide, then THM's and THAA's would form. Chlorine dioxide oxidizes the humic and fulvic acids, and other natural organics, into a form that do not react with chlorine or hypochlorus, or otherwise minimizes the chlorine and hypochlorus acid reaction with the organics that otherwise would be chlorinated.

In accordance with one or more embodiments, a high purity chlorine dioxide stream, such as one at greater than about 95% molar conversion efficiency, may be generated from chlorite to chlorine dioxide containing less than about 5% excess chlorine in the feed stream exiting the generator. Alternatively, a mixed oxidant stream of chlorine dioxide that contains excess chlorine, such as greater than about 5%, can be produced while still achieving at least about 95% molar conversion efficiency of chlorite to chlorine dioxide. The amount of excess chlorine in the exiting generator stream desired may be dialed-in. In some embodiments, no pH control may be used. In other embodiments, no reagent metering pumps may be used. In accordance with one or more embodiments, systems and methods may be automatically controlled with generator self-tuning capabilities via use of two optical sensors interfaced with the generators PLC program control system. A first optical sensor may detect a concentration of chlorine dioxide at an outlet, and a second optical sensor may be associated with a reactant feed stream, such as to detect or monitor reactant bleach concentration.

In some non-limiting embodiments, systems and methods may produce chlorine dioxide in an amount of about 100 to 1000 pounds per day. cA resultant solution may, in some non-limiting embodiments, have a concentration of about 50 to 2500 parts per million.

In accordance with one or more embodiments, components may be designed specifically to monitor and control the feed of three chemicals (sodium chlorite solution, sodium hypochlorite solution, and hydrochloric acid solution) accurately and consistently. A feed water system may provide consistent supply of water flow and pressure to the chlorine dioxide generator. When a start signal is received or initiated, an input water solenoid valve may be activated to open and a booster pump starts. A water flow sensor may provide a signal to a process controller that allows the system to continue to operate so long as an adequate water flow rate exists. Chemical flows may be initiated by a vacuum eductor and the three chemical flow control valves may be sent a signal by the controller. A PID loop may automatically control the flow of each precursor as required for a chlorine dioxide set point. A sodium hypochlorite optical analyzer may monitor that precursor concentration and automatically adjust the feed to the required amount to insure that the chemical reactions are optimized. All chemical feeds may be continuously monitored and controlled by separate PID flow control loops. Additional control features may allow the operator to monitor and control the chemical feeds manually.

An optical chlorine dioxide analyzer may be installed with respect to the generator effluent to provide real time information to the PLC for efficiency monitoring and control. The feed rate of each chemical precursor may be optimized using real time adjustments based upon an efficiency calculation that compares the analyzer measured concentration to the calculated concentration based upon sodium chlorite eductor feed water flows.

The chlorine dioxide feed process may be controlled using a variety of methods which generally provide information to the controller that allows for fully automated flow pace and dosage feed.

For flow pace control, an operator may have several choices. If only a flow signal is sent to the generator, the operator can place the Set Point control in Automatic and the Dosage in Manual. The dosage can then be set at whatever value required, such as 1.0. The internal dosage signal may generally be a multiplier of the Set Point value whether or not it is in Automatic or Manual mode.

If the operator can supply both a flow and a dosage signal, then the unit may be run with both modes in Automatic. In that case, the dosage signal may still act as a multiplier of the set point. A calculation may be required to insure that the maximum dosage multiplied by the maximum set point input values does not exceed the capacity of the unit. An alarm may be initiated should this condition occur.

For all automatic signals input to the unit, the Remote Set Point Scale setup screen enables the operator to input the proper values for Set Point (PPD) and Dosage (PPM). Other methods of automatic control may be utilized. A desired feed range may be input to the unit. In some embodiments, about a 4 to 20 mA signal representing the desired feed range is input to the unit. Local feed control may be implemented by entering the amount of chlorine dioxide desired. The output will be the amount entered.

In accordance with one or more embodiments, various operational parameters may be monitored including but not limited to water flow rate, production set point deviation, reactant (sodium chlorite, sodium hypochlorite or hydrochloric acid) set point deviation, flow meter signals, control valve connections, remote set point (PPD), remote dosage (PPM), and optical analyzer deviation or functionality.

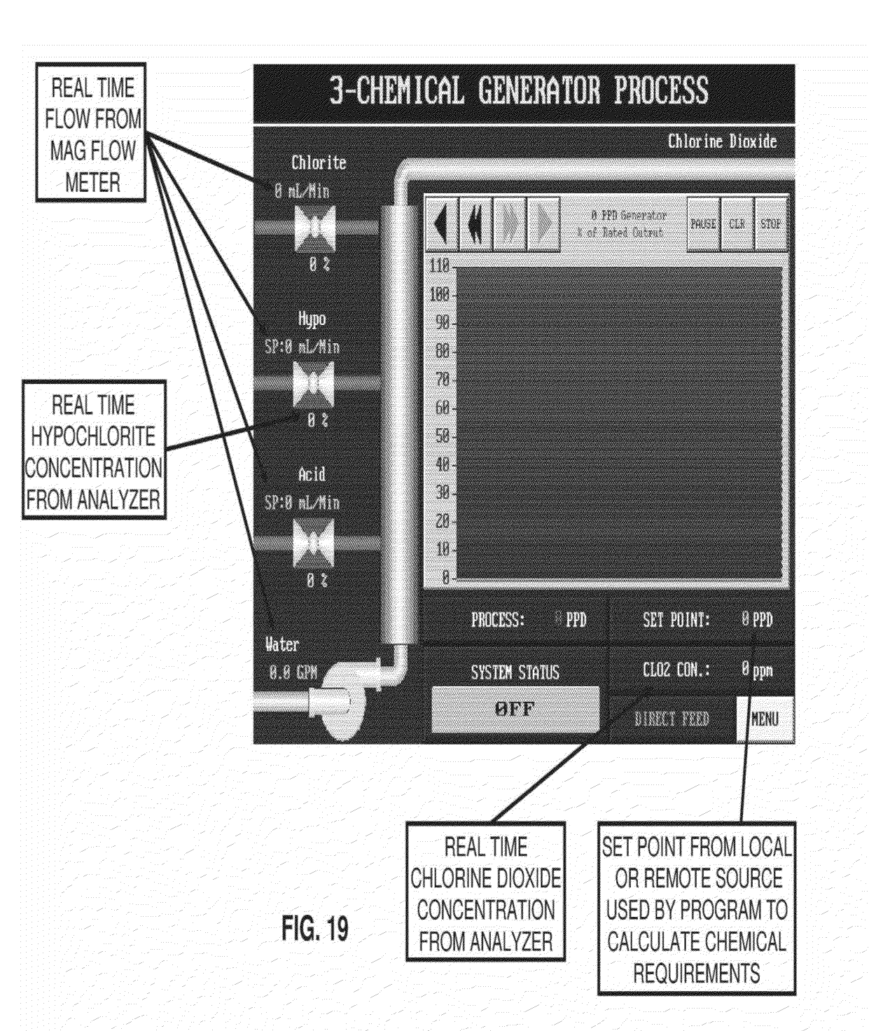

In accordance with one or more embodiments, various display screens associated with a user interface may allow for complete control of all operating parameters. FIG. 19 presents a controller user interface snapshot in accordance with one or more embodiments. A process trend screen may show current operating conditions and the current set point. The real time set point and process variable may be displayed graphically. A Set Point PPD display may allow the operator to view and set the local dosage in pounds per day. REMOTE may be selected for a flow paced input and the REMOTE SET POINT value may be displayed. Analog input screens are available for calibration of the incoming signal, with the resultant REMOTE SP displayed. A Generator Dosage screen may be implemented for dosage control and local dosage can be set as desired. If REMOTE is selected, the dosage set point may be provided by an incoming 4-20 mA signal in some non-limiting embodiments. Analog input screens are available for calibration of the incoming dosage signal, with the resultant REMOTE DOSING SP displayed. Other screens may provide the status of the variety of alarm conditions that are monitored. An Analog Input screen may allow for each measurement device in the system to be specifically calibrated to produce the most accurate control and efficient generation of chlorine dioxide. The Remote SP (PPD) and Remote (PPM) may allow the operator to define the input signals. Both the pounds per day (Flow Pace) and dosage input signals may have the 20 mA (span) signals set to the desired values in some non-limiting embodiments. The actual input value may be displayed in each case. A Chlorite PID screen may allow for adjustment of the chlorite flow control valve. Under certain circumstances the chlorite valve may be in the AUTO position. The Set Point (SP) and Process Variable (PV) may be displayed both graphically and numerically. The valve can also be opened manually in the MANUAL mode by entering numerically the valve percentage open position. A PID Loop Equation Parameters screen may be used for tuning the PID control loops.

In accordance with one or more embodiments, during startup the expected total chlorine dioxide demand at the injection point should be determined. The generator production set point can be set or adjusted at any time. The process controller may automatically calculate the required flow rate for sodium chlorite and chlorine gas. This automatic control may be evident in either the local (ppd entered by operator) or remote mode (analog flow pace signal from plant).

The systems and methods disclosed herein are widely applicable to all water disinfection and oxidation needs, including industrial, municipal, food, beverage, paper and oilfield applications.

In one non-limiting embodiment, gold ores and slogs may be treated with chlorine dioxide. Bleach or chlorine may be added separately via another independent chemical feed system at a defined dosing/concentration level, so as to increase ORP and to optimize oxidation of the ores natural carbon and sulfidic linkages to more effectively release and solubilize the gold, or other precious recoverable metals. The simultaneous addition of excess bleach or chlorine can be accomplished through the system generator by automatically increasing bleach feed, or the bleach and acid feed, or reducing chlorite feed, if the actual real time bleach concentration that is being fed to the generators reaction column is measured in accordance with the one or more embodiments described herein. The feed rate can then automatically be adjusted via the PLC and optical controller sensor interface.

The function and advantages of these and other embodiments will be more fully understood from the following example. The example is intended to be illustrative in nature and is not to be considered as limiting the scope of the embodiments discussed herein.

### Prophetic Example

At 95% molar conversion efficiency, it may generally require about 5.64 lbs 25% sodium chlorite per pound of chlorine dioxide produced. At 100% molar conversion efficiency, it may generally require about 5.36 lbs 25% sodium chlorite per pound of chlorine dioxide produced. Assuming a production rate of 250 lbs per day of chlorine dioxide, then 514,650 lbs of sodium chlorite may be required per year at a 95% molar conversion efficiency. At the same production rate, 489,100 lbs of sodium chlorite may be required per year at a 100% conversion efficiency. Assuming a 98% conversion efficiency, 499,082 lbs of sodium chlorite may be required per year which would be associated with significant cost savings in terms of raw materials in comparison to the conventional 95% molar conversion efficiency. The savings may generally multiply depending on the quantity of chlorine dioxide generated.

The herein disclosed embodiments have been presented without providing for the electronic circuitry since this circuitry would be readily understood by those skilled in the art.

Many modifications may be made without departing from the basic spirit of the present invention. Accordingly, it will be appreciated by those skilled in the art that the invention may be practiced other than has been specifically described herein.

Having now described some illustrative embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

It is to be appreciated that embodiments of the devices, systems and methods discussed herein are not limited in application to the details of construction and the arrangement of components set forth in the following description or illustrated in the accompanying drawings. The devices, systems and methods are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of generating chlorine dioxide, comprising:
supplying sodium chlorite and chlorine to a reaction column under vacuum;
measuring a flow rate of sodium chlorite supplied to the reaction column;
measuring a concentration of sodium chlorite supplied to the reaction column;
measuring a generated chlorine dioxide yield at an outlet of the reaction column;
determining a theoretical chlorine dioxide yield based on the measured flow rate and the measured concentration of sodium chlorite;
determining a process efficiency by comparing the theoretical chlorine dioxide yield to the generated chlorine dioxide yield measured;
comparing the process efficiency to a set point value; and
adjusting the flow rate of at least one of sodium chlorite and chlorine to the reaction column if the process efficiency deviates from the set point value.

2. The method of claim 1, wherein the concentration of sodium chlorite is measured with an optical analyzer.

3. The method of claim 1, wherein adjusting the flow rate of at least one of sodium chlorite and chlorine is not dependent on linearity of the flow rate with respect to a valve positioning.

4. The method of claim 1, wherein the flow rate of sodium chlorite is adjusted in response to the process efficiency deviating from the set point value.

5. The method of claim 4, wherein the flow rate of sodium chlorite to the reaction column is continuously adjusted.

6. The method of claim 1, wherein the process efficiency is at least about 98% with respect to molar conversion.

7. A method of generating chlorine dioxide, comprising:
supplying sodium chlorite, hydrochloric acid, and sodium hypochlorite to a reaction column under vacuum;
measuring a flow rate of sodium chlorite supplied to the reaction column;
measuring a concentration of sodium chlorite supplied to the reaction column;
measuring a generated chlorine dioxide yield at an outlet of the reaction column;
determining a theoretical chlorine dioxide yield based on the measured flow rate and the measured concentration of sodium chlorite supplied to the reaction column;
determining a process efficiency by comparing the theoretical chlorine dioxide yield to the generated chlorine dioxide yield measured;
comparing the process efficiency to a set point value; and
adjusting the flow rate of at least one of sodium chlorite, hydrochloric acid and sodium hypochlorite if the process efficiency deviates from the set point value.

8. The method of claim 7, further comprising measuring a flow rate of sodium hypochlorite supplied to the reaction column.

9. The method of claim 8, further comprising measuring a concentration of sodium hypochlorite supplied to the reaction column.

10. The method of claim 7, wherein the flow rate of sodium chlorite is adjusted in response to the process efficiency deviating from the set point value.

11. The method of claim 10, wherein the flow rate of sodium chlorite to the reaction column is continuously adjusted.

12. The method of claim 10, wherein the flow rate of sodium hypochlorite is adjusted in response to the process efficiency deviating from the set point value.

13. The method of claim 7, wherein the process efficiency is at least about 98% with respect to molar conversion.

14. A chlorine dioxide generation system, comprising:
a reactor column;
a source of sodium chlorite reactant fluidly connected to the reaction column;
a source of chlorine gas reactant fluidly connected to the reaction column;
a first sensor configured to detect a flow rate of at least one of sodium chlorite and chlorine gas delivered to the reaction column;
a second sensor configured to detect a chlorine dioxide concentration of a product stream generated by the system;
a third sensor configured to detect a sodium chlorite concentration delivered to the reaction column; and
a controller, in communication with the first, second, and third sensors, configured to:
determine a theoretical chlorine dioxide production rate based on the flow rate of the at least one of sodium chlorite and chlorine gas detected by the first sensor and the sodium chlorite concentration detected by the third sensor;
determine an actual chlorine dioxide production rate based on the chlorine dioxide concentration detected by the second sensor;
monitor a process efficiency based on the theoretical chlorine dioxide production rate and the actual chlorine dioxide production rate; and
adjust the flow rate of at least one of sodium chlorite and chlorine gas to the reaction column based on the process efficiency.

15. The system of claim 14, wherein the third sensor comprises an optical analyzer.

16. The system of claim 14, characterized by a molar conversion efficiency of at least about 98%.

17. A chlorine dioxide generation system, comprising:
a reaction column;
a source of sodium chlorite reactant fluidly connected to the reaction column;
a source of sodium hypochlorite reactant fluidly connected to the reaction column;
a source of hydrochloric acid reactant fluidly connected to the reaction column;
a first sensor configured to detect a flow rate of at least one of sodium chlorite, sodium hypochlorite, and hydrochloric acid delivered to the reaction column;
a second sensor configured to detect a chlorine dioxide concentration of a product stream generated by the system;
a third sensor configured to detect a concentration of sodium chlorite reactant delivered to the reaction column; and
a controller, in communication with the first, second, and third sensors, configured to:
determine a theoretical chlorine dioxide production rate based on the flow rate of the at least one of sodium chlorite, sodium hypochlorite, and hydrochloric acid detected by the first sensor and the sodium chlorite concentration detected by the third sensor;
determine an actual chlorine dioxide production rate based on the chlorine dioxide concentration detected by the second sensor;
monitor a system efficiency based on the theoretical chlorine dioxide production rate and the actual chlorine dioxide production rate; and
adjust the flow rate of at least one of sodium chlorite, sodium hypochlorite, and hydrochloric acid to the reaction column based on the process efficiency.

18. The system of claim 17, further comprising a fourth sensor configured to detect a sodium hypochlorite concentration delivered to the reaction column, and wherein the controller is in further communication with the fourth sensor.

19. The system of claim 18, wherein the controller is configured to adjust the flow rates of both sodium chlorite and sodium hypochlorite to the reaction column.

20. The system of claim 17, characterized by a molar conversion efficiency of at least about 98%.
